(19) United States
(12) Patent Application Publication
(10) Pub. No.: US 2021/0082135 A1
(43) Pub. Date: Mar. 18, 2021

(54) METHOD AND DEVICE FOR DEPTH IMAGE COMPLETION AND COMPUTER-READABLE STORAGE MEDIUM

(71) Applicant: SHANGHAI SENSETIME LINGANG INTELLIGENT TECHNOLOGY CO., LTD., Shanghai (CN)

(72) Inventors: Yan XU, Shanghai (CN); Xinge Zhu, Shanghai (CN); Jianping Shi, Shanghai (CN); Guofeng Zhang, Shanghai (CN); Hongsheng Li, Shanghai (CN)

(21) Appl. No.: 17/107,065

(22) Filed: Nov. 30, 2020

Related U.S. Application Data
(63) Continuation of application No. PCT/CN2019/128828, filed on Dec. 26, 2019.

(30) Foreign Application Priority Data
Aug. 30, 2019 (CN) 201910817815.1

(51) Int. Cl. G06T 7/529; G06T 7/73

(52) U.S. Cl. CPC G06T 7/529; G06T 2207/10044; G06T 2207/10016; G06T 7/74

(57) ABSTRACT

Provided are a method and device for depth image completion and a computer-readable storage medium. The method includes that: a depth image of a target scenario is collected through an arranged radar, and a Two-Dimensional (2D) image of the target scenario is collected through an arranged video camera; a to-be-diffused map and a feature map are determined based on the collected depth image and 2D image; a diffusion intensity of each pixel in the to-be-diffused map is determined based on the to-be-diffused map and the feature map, the diffusion intensity representing an intensity of diffusion of a pixel value of each pixel in the to-be-diffused map to an adjacent pixel; and a completed depth image is determined based on the pixel value of each pixel in the to-be-diffused map and the diffusion intensity of each pixel in the to-be-diffused map.

### CROSS-REFERENCE TO RELATED APPLICATION

The present application is a continuation of International Patent Application No. PCT/CN2019/128828, filed on Dec. 26, 2019, which claims priority to Chinese Patent Application No. 201910817815.1, filed on Aug. 30, 2019. The disclosures of International Patent Application No. PCT/CN2019/128828 and Chinese Patent Application No. 201910817815.1 are hereby incorporated by reference in their entireties.

### TECHNICAL FIELD

The disclosure relates to an image processing technology, and particularly to a method and device for depth image completion and a non-transitory computer-readable storage medium.

### BACKGROUND

At present, a commonly used method for depth image acquisition is to obtain a depth image of a Three-Dimensional (3D) scenario by a Light Detection And Ranging (LiDAR) sensor, a binocular camera, a Time of Flight (TOF) sensor and the like. The binocular camera and the TOF sensor have effective distances not longer than 10 m and are usually applied to a terminal such as a smart phone. LiDAR has a longer effective distance which may reach dozens of meters or even hundreds of meters, and thus can be applied to the fields of piloted driving, robots and the like.

When an depth image is acquired by LiDAR, a laser beam is emitted to a 3D scenario, then a laser beam reflected by a surface of each object in the 3D scenario is received, and a time difference between an emission moment and a reflection moment is calculated, thereby obtaining the depth image of the 3D scenario. However, in practical use, 32/64-line LiDAR is mostly adopted, so that only a sparse depth image can be acquired. Depth image completion refers to a process of restoring a depth image to a dense depth image. In related art, depth image completion refers to directly inputting a depth image to a neural network to obtain a dense depth image. However, in this manner, sparse point cloud data is not fully utilized, and consequently, the accuracy of the obtained dense depth image is low.

### SUMMARY

According to a first aspect, embodiments of the disclosure provide a method for depth image completion, which may include the following operations.

A depth image of a target scenario is collected through an arranged radar, and a two-dimensional (2D) image of the target scenario is collected through an arranged video camera.

A to-be-diffused map and a feature map are determined based on the collected depth image and the collected 2D image.

A diffusion intensity of each pixel in the to-be-diffused map is determined based on the to-be-diffused map and the feature map, the diffusion intensity representing an intensity of diffusion of a pixel value of each pixel in the to-be-diffused map to an adjacent pixel.

A completed depth image is determined based on the pixel value of each pixel in the to-be-diffused map and the diffusion intensity of each pixel in the to-be-diffused map.

According to a second aspect, the embodiments of the disclosure provide a device for depth image completion, which may include a collection module, a processing module and a diffusion module.

The collection module may be configured to collect a depth image of a target scenario through an arranged radar and collect a 2D image of the target scenario through an arranged video camera.

The processing module may be configured to determine a to-be-diffused map and a feature map based on the collected depth image and the collected 2D image and determine a diffusion intensity of each pixel in the to-be-diffused map based on the to-be-diffused map and the feature map, the diffusion intensity representing an intensity of diffusion of a pixel value of each pixel in the to-be-diffused map to an adjacent pixel.

The diffusion module may be configured to determine a completed depth image based on the pixel value of each pixel in the to-be-diffused map and the diffusion intensity of each pixel in the to-be-diffused map.

According to a third aspect, the embodiments of the disclosure also provide a device for depth image completion, which may include a memory and a processor.

The memory may be configured to store executable depth image completion instructions.

The processor may be configured to execute the executable depth image completion instructions stored in the memory to implement any method of the first aspect.

According to a fourth aspect, the embodiments of the disclosure provide a computer-readable storage medium, which may store executable depth image completion instructions, configured to be executed by a processor to implement any method of the first aspect.

### BRIEF DESCRIPTION OF THE DRAWINGS

FIG. 1 is a first flowchart of a method for depth image completion according to an embodiment of the disclosure.

FIG. 2 is a second flowchart of a method for depth image completion according to an embodiment of the disclosure.

FIG. 3 is a schematic diagram of calculating a first plane origin distance map according to an embodiment of the disclosure.

FIG. 4A is a schematic diagram of a noise of a collected depth image according to an embodiment of the disclosure.

FIG. 4B is a schematic diagram of a first confidence map according to an embodiment of the disclosure.

FIG. 5 is a third flowchart of a method for depth image completion according to an embodiment of the disclosure.

FIG. 6 is a first process diagram of a method for depth image completion according to an embodiment of the disclosure.

FIG. 7 is a second process diagram of a method for depth image completion according to an embodiment of the disclosure.

FIG. 8 is a third process diagram of a method for depth image completion according to an embodiment of the disclosure.

FIG. 9 is a fourth flowchart of a method for depth image completion according to an embodiment of the disclosure.

FIG. 10 is a fifth flowchart of a method for depth image completion according to an embodiment of the disclosure.

FIG. 11 is a schematic diagram of a diffused pixel value of a second pixel of a to-be-diffused map according to an embodiment of the disclosure.

FIG. 12A is a first schematic diagram of an impact of a value of a preset repetition times on an error of a completed depth image according to an embodiment of the disclosure.

FIG. 12B is a second schematic diagram of an impact of a value of a preset repetition times on an error of a completed depth image according to an embodiment of the disclosure.

FIG. 13A is a schematic diagram of an impact of a preset error tolerance parameter on a first confidence map according to an embodiment of the disclosure.

FIG. 13B is a schematic diagram of an impact of a preset error tolerance parameter on a truth value-Absolute Error (AE) curve distribution of confidence according to an embodiment of the disclosure.

FIG. 14A is a first schematic diagram of an impact of a sampling rate of a preset prediction model on a completed depth image according to an embodiment of the disclosure.

FIG. 14B is a second schematic diagram of an impact of a sampling rate of a preset prediction model on a completed depth image according to an embodiment of the disclosure.

FIG. 15A is a schematic diagram of a collected depth image and 2D image of a 3D scenario according to an embodiment of the disclosure.

FIG. 15B is a completed depth image obtained by a Convolutional Spatial Propagation Network (CSPN) according to an embodiment of the disclosure.

FIG. 15C is a completed depth image obtained by an NConv-Convolutional Neural Network (CNN) according to an embodiment of the disclosure.

FIG. 15D is a completed depth image obtained by a sparse-to-dense method in related art.

FIG. 15E is a normal prediction map according to an embodiment of the disclosure.

FIG. 15F is a first confidence map according to an embodiment of the disclosure.

FIG. 15G is a completed depth image according to an embodiment of the disclosure.

FIG. 16 is a structure diagram of a device for depth image completion according to an embodiment of the disclosure.

FIG. 17 is a composition structure diagram of a device for depth image completion according to an embodiment of the disclosure.

### DETAILED DESCRIPTION

The technical solutions in the embodiments of the disclosure will be clearly and completely described below in combination with the drawings in the embodiments of the disclosure.

Along with the development of image processing technologies, more and more devices can obtain depth images and further process the depth images to realize various functions. A commonly used depth image acquisition method is to obtain a depth image of a 3D scenario by a LiDAR sensor, a millimeter wave radar, a binocular camera, a TOF sensor and the like. However, effective distances of the binocular camera and the TOF sensor for depth image acquisition are usually within 10 m, and thus the binocular camera and the TOF sensor are usually applied to a terminal such as a smart phone to obtain a depth image of an object such as a face. An effective distance of LiDAR is longer and can reach dozens of meters or even hundreds of meters, and thus LiDAR can be applied to the fields of piloted driving, robots and the like.

When a depth image is acquired by LiDAR, a laser beam is actively emitted to a 3D scenario, then a laser beam reflected by a surface of each object in the 3D scenario is received, and a depth image of the 3D scenario is obtained based on a time difference between emission time when the laser beam is emitted and receiving time when the reflected laser beam is received. The depth image is acquired by LiDAR based on the time difference of the laser beam, so that the depth image obtained by LiDAR consists of sparse point cloud data. Moreover, in practical application, 32/64-line LiDAR is mostly adopted, so that only a sparse depth image can be obtained, and depth completion is needed to be performed to convert the sparse depth image to a dense depth image. In related art, a method for depth image completion is to perform supervised training on a neural network model based on training data consisting of a large number of sparse depth images and 2D images of 3D scenarios to obtain a trained neural network model and then directly inputting a sparse depth image and a 2D image of a 3D scenario to the trained neural network model to implement depth completion to obtain a denser depth image. However, in this manner, point cloud data in the depth image is not fully utilized, and the accuracy of the obtained depth image is relatively low.

Aiming at the problems of the abovementioned depth completion method, the embodiments of the disclosure propose that a to-be-diffused map is obtained at first based on a collected sparse depth image and a 2D image of a 3D scenario and then pixel-level diffusion is implemented on the to-be-diffused map to obtain a completed depth image, so that each piece of sparse point cloud data in the sparse depth image is fully utilized, and a more accurate completed depth image is obtained.

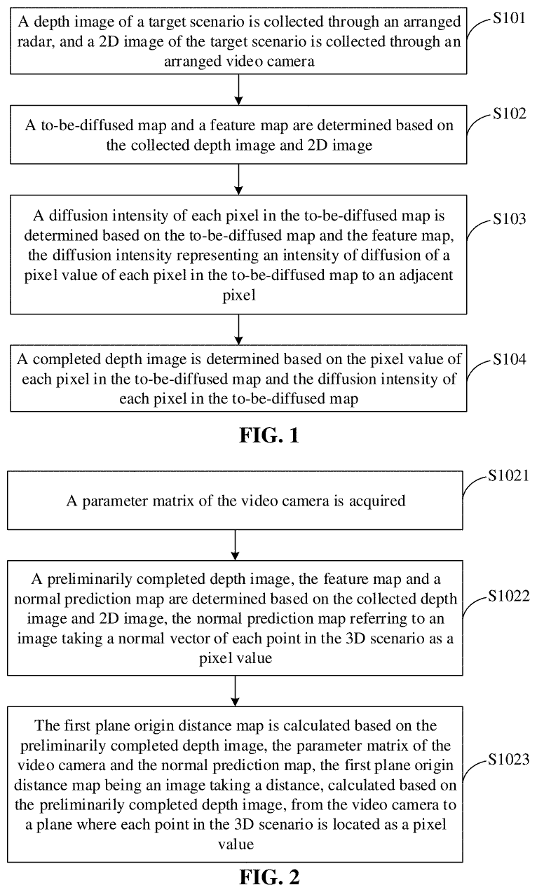

Based on the idea of the embodiments of the disclosure, the embodiments of the disclosure provide a method for depth image completion. Referring to FIG. 1, the method may include the following operations.

In S101, a depth image of a target scenario is collected through an arranged radar, and a 2D image of the target scenario is collected through an arranged video camera.

The embodiment of the disclosure is implemented in a scenario of performing depth image completion on a collected sparse depth image. At first, a depth image of a target scenario is collected through an arranged radar, and meanwhile, a 2D image of the target scenario is collected through a video camera arranged on a device.

It is to be noted that, when a depth image is collected through the arranged radar, the depth image may be obtained by calculating depth information of a 3D point corresponding to a laser beam in a 3D scenario based on a time difference between emission time and receiving time of the laser beam and determining the calculated depth information as a pixel value. The depth image may also be obtained by calculating the depth information of the 3D point corresponding to the laser beam based on another characteristic such as phase information of the laser beam. No limits are made in the embodiments of the disclosure.

It is to be noted that, in an embodiment of the disclosure, the depth image collected through the radar is a sparse depth image.

In an embodiment of the disclosure, the arranged radar may be a 32/64-line LiDAR sensor or may be a millimeter wave radar or a radar of another type. No limits are made in the embodiments of the disclosure.

In an embodiment of the disclosure, when a 2D image is collected through the arranged video camera, the 2D image may be obtained by obtaining pixel value information of each 3D point in a 3D scenario through an optical device of a color video camera. The 2D image of the target scenario may also be obtained in another manner No limits are made in the embodiments of the disclosure.

In some embodiments of the disclosure, the arranged video camera may be a color video camera that can obtain a colored 2D image of a 3D scenario, or may be an infrared video camera that can obtain an infrared grayscale map of a 3D scenario. The arranged video camera may also be a video camera of another type. No limits are made in the embodiments of the disclosure.

It is to be noted that, in an embodiment of the disclosure, resolutions of the collected depth image and 2D image may be the same or may be different. When the resolutions of the collected depth image and 2D image are different, a scaling operation may be executed on any one of the collected depth image and 2D image to keep the resolutions of the collected depth image and 2D image the same.

In an embodiment of the disclosure, the radar and the video camera may be arranged and laid out based on a practical requirement. No limits are made in the embodiments of the disclosure.

In S102, a to-be-diffused map and a feature map are obtained based on the collected depth image and 2D image.

In S103, a diffusion intensity of each pixel in the to-be-diffused map is determined based on the to-be-diffused map and the feature map, the diffusion intensity representing an intensity of diffusion of a pixel value of each pixel in the to-be-diffused map to an adjacent pixel, to determine a degree of diffusion of the pixel value of each pixel in the to-be-diffused map to the adjacent pixel based on the diffusion intensity.

It is to be noted that, when the diffusion intensity of each pixel in the to-be-diffused map is determined based on the to-be-diffused map and the feature map, some adjacent pixels are required to be determined for each pixel in the to-be-diffused map, and then similarities between each pixel and the corresponding adjacent pixels may be obtained by comparison one by one to determine the diffusion intensity.

In S104, a completed depth image is determined based on the pixel value of each pixel in the to-be-diffused map and the diffusion intensity of each pixel in the to-be-diffused map.

In an embodiment of the disclosure, since the to-be-diffused map is determined based on the depth image and the 2D image, all point cloud data in the collected depth image may be retained in the to-be-diffused map, and when a diffused pixel value of each pixel in the to-be-diffused map is determined based on the pixel value of each pixel in the to-be-diffused map and the corresponding diffusion intensity, all the point cloud data in the collected depth image may be utilized. Therefore, the accuracy of obtained depth information corresponding to each 3D point in a 3D scenario becomes higher, and the accuracy of the completed depth image is improved.

In some embodiments of the disclosure, an implementation process of the operation that the completed depth image is determined based on the pixel value of each pixel in the to-be-diffused map and the diffusion intensity of each pixel in the to-be-diffused map, i.e., S104, may include the following operations S1041 to S1042.

In S1041, a diffused pixel value of each pixel in the to-be-diffused map is determined based on the pixel value of each pixel in the to-be-diffused map and the diffusion intensity of each pixel in the to-be-diffused map.

In S1042, the completed depth image is determined based on the diffused pixel value of each pixel in the to-be-diffused map.

It is to be noted that the completed depth image in an embodiment of the disclosure refers to a denser completed depth image that includes more comprehensive depth information of a 3D scenario and may be directly applied to various scenarios requiring depth images.

In an embodiment of the disclosure, when the diffused pixel value of each pixel in the to-be-diffused map is calculated based on the pixel value of each pixel in the to-be-diffused map and the corresponding diffusion intensity and the completed depth image is determined based on the diffused pixel value of each pixel in the to-be-diffused map, all the point cloud data in the collected depth image may be utilized, so that the accuracy of obtained depth information corresponding to each 3D point in the 3D scenario becomes higher, and the accuracy of the completed depth image is improved.

Based on the same concept of the abovementioned embodiment, in some embodiments of the disclosure, the to-be-diffused map is a preliminarily completed depth image. An implementation process of the operation that the completed depth image is determined based on the diffused pixel value of each pixel in the to-be-diffused map, i.e., S1042, may include the following operations S1042a to S1042b.

In S1042a, the diffused pixel value of each pixel in the to-be-diffused map is determined as a pixel value of each pixel of a diffused image.

In S1042b, the diffused image is determined as the completed depth image.

It is to be noted that the preliminarily completed depth image obtained for the first time may be an image obtained based on the collected depth image and 2D image, i.e., an image obtained by performing plane division, depth information padding and the like on the collected depth image and 2D image to obtain the depth information of each 3D point in the 3D scenario and determining the obtained depth information of each 3D point as a pixel value. Or, the preliminarily completed depth image obtained for the first time may be obtained by processing the collected depth image and 2D image by related art. A density of point cloud data in the preliminarily completed depth image is higher than a depth of the point cloud data in the collected depth image.

In an embodiment of the disclosure, the diffused pixel value of each pixel in the to-be-diffused map may be determined as the pixel value of each pixel of the diffused image and the diffused image may be determined as the completed depth image. In such a manner, all the point cloud data in the collected depth image may be utilized, so that a completed depth image with a better effect may be obtained by full use of the point cloud data in the depth image.

In some embodiments of the disclosure, the to-be-diffused map is a first plane origin distance map. In such case, as shown in FIG. 2, an implementation process of the operation that the to-be-diffused map and the feature map are determined based on the collected depth image and 2D image, i.e., S102, may include the following operations S1021 to S1023.

In S1021, a parameter matrix of the video camera is acquired.

It is to be noted that the acquired parameter matrix is an inherent parameter matrix of the video camera. The parameter matrix may refer to an intrinsic parameter matrix of the video camera and may include a projective transformation parameter and a focal length of the video camera. The parameter matrix may also include another parameter required for calculation of the first plane origin distance map. No limits are made in the embodiments of the disclosure.

In S1022, a preliminarily completed depth image, a feature map and a normal prediction map are determined based on the collected depth image and 2D image, the normal prediction map referring to an image taking a normal vector of each point in the 3D scenario as a pixel value.

In an embodiment of the disclosure, the normal prediction map refers to an image obtained by determining a surface normal vector of each 3D point in the 3D scenario as a pixel value. The surface normal vector of a 3D point is defined as a vector starting from the 3D point and perpendicular to a tangent plane of the 3D point.

It is to be noted that the preliminarily completed depth image obtained for the first time refers to an image determined based on the collected depth image and 2D image and taking preliminary depth information of each 3D point in the 3D scenario as a pixel value.

In S1023, the first plane origin distance map is calculated based on the preliminarily completed depth image, the parameter matrix of the video camera and the normal prediction map, the first plane origin distance map being an image taking a distance, calculated based on the preliminarily completed depth image, from the video camera to a plane where each point in the 3D scenario is located as a pixel value.

After the preliminarily completed depth image, the parameter matrix and the normal prediction map are obtained, a first plane origin distance may be calculated for each 3D point based on the pixel value of each pixel in the preliminarily completed depth image, the parameter matrix and the pixel value of each pixel in the normal prediction map, and then the first plane origin distance map may be obtained by determining the first plane origin distance of each 3D point as a pixel value, so that a diffused pixel value may be subsequently calculated for each pixel in the first plane origin distance map based on the first plane origin distance map and the feature map to obtain the completed depth image.

In an embodiment of the disclosure, the first plane origin distance refers to a distance, calculated based on the preliminarily completed depth image, from a center of the video camera to a tangent plane where each 3D point in the 3D scenario is located.

Since the first plane origin distance map is an image obtained by taking the first plane origin distance of each 3D point, i.e., the distance from the center of the video camera to the tangent plane where the 3D point is located, as a pixel value, the 3D points on the same tangent plane may have the same or similar first plane origin distances. If the first plane origin distance of a certain 3D point is greatly different from a first plane origin distance of another 3D point on the same tangent plane as the 3D point, it is indicated that the first plane origin distance of the 3D point is an exceptional value required to be corrected, namely there is a geometric constraint for the 3D points on the same tangent plane. Based on the geometric constraint, when A diffused pixel value is calculated for each pixel in the first plane origin distance map based on the first plane origin distance map and the feature map, an exceptional value in the first plane origin distance map may be corrected to obtain a first plane origin distance map with higher accuracy, and a completed depth image with a better effect may further be obtained based on the first plane origin distance map with higher accuracy.

In an embodiment of the disclosure, the first plane origin distance of each 3D point in the 3D scenario is required to be calculated at first, and then the first plane origin distance map may be obtained by determining the first plane origin distance of each 3D point as a pixel value. When the first plane origin distance of each 3D point is calculated, a 2D projection of each 3D point on an image plane is required to be determined at first, inversion may be performed on the parameter matrix of the video camera to obtain an inverse matrix of the parameter matrix, then the preliminary depth information corresponding to each 3D point may be obtained from the preliminarily completed depth image, the normal vector of the tangent plane where each 3D point is located may be obtained from the normal prediction map, and finally, the preliminary depth information corresponding to each 3D point, the normal vector of the tangent plane where each 3D point is located, the inverse matrix of the parameter matrix and the 2D projection of the 3D point on the plane image may be multiplied to obtain the first plane origin distance of each 3D point.

Exemplarily, in an embodiment of the disclosure, a formula for calculating the first plane origin distance of a 3D point is provided, as shown in the formula (1):

P(x)=D(x)N(x)C⁻¹x (1).

P(x) represents the first plane origin distance of a 3D point, x represents the 2D projection of the 3D point on an image plane, D(x) represents preliminary depth information corresponding to the 3D point, N(x) represents a normal vector of a tangent plane where the 3D point X is located, and C represents a parameter matrix. Therefore, after a coordinate value of the 2D projection of the 3D point on the image plane, a numerical value of the preliminary depth information corresponding to the 3D point and the normal vector of the tangent plane where the 3D point is located are obtained, the obtained data may be substituted into the formula (1) to calculate the first plane origin distance of the 3D point. Then, the first plane origin distance map may be obtained by determining the first plane origin distance of each 3D point as a pixel value.

It is to be noted that a calculation formula for a first plane origin distance of a 3D point may be derived from a geometrical relationship. It can be seen from the geometrical relationship that the distance from the center of the video camera to a tangent plane where a 3D point is located may be determined by any point on a plane where the 3D point is located and the normal vector of the plane where the 3D point is located, and a 3D coordinate of the 3D point may be calculated by the 2D projection of the 3D point on the image plane, the preliminary depth information of the 3D point and the parameter matrix, so that the distance from the center of the video camera to the tangent plane where the 3D point is located may be calculated by the preliminary depth information of the 3D point, the normal vector of the plane where the 3D point is located, the parameter matrix and the 2D projection. For the preliminarily completed depth image, position information of each pixel is the 2D projection of the corresponding 3D point, and the pixel value of each pixel is the depth information corresponding to the 3D point. Similarly, for the normal prediction map, position information of each pixel is the 2D projection of the corresponding 3D point, and the pixel value of each pixel is normal vector information of the 3D point. Therefore, the first plane origin distances of all the 3D points may be obtained from the preliminarily completed depth image, the normal prediction map and the parameter matrix.

Exemplarily, in an embodiment of the disclosure, a process of deriving a calculation formula for a first plane origin distance of a 3D point based on a geometrical relationship, i.e., a process of deriving the formula (1), is presented.

It can be seen according to the geometrical relationship that a relationship between a 3D point in a 3D scenario and a distance of a tangent plane where the 3D point is located may be shown as the formula (2):

N(x)·X−P(x)=0 (2).

X represents a 3D point in a 3D scenario, x represents a 2D projection of the 3D point on an image plane, N(x) represents a normal vector starting from the 3D point X and perpendicular to a tangent plane where the 3D point X is located, and P(x) represents a distance from the center of the video camera to the tangent plane where the 3D point X is located, i.e., the preliminary depth information of the 3D point.

The formula (2) may be transformed to obtain the formula (3):

P(x)=N(x)·x (3).

The 3D point in the 3D scenario may be represented by the formula (4):

X=D(x)·C⁻¹x (4).

x represents the 3D point in the 3D scenario, x represents the 2D projection of the 3D point on the image plane, D(x) represents the preliminary depth information corresponding to the 3D point, and C represents the parameter matrix.

The formula (4) may be substituted into the formula (3) to obtain the formula (1).

Exemplarily, the embodiment of the disclosure provides a schematic diagram of calculating the first plane origin distance map. As shown in FIG. 3, O is the center of the video camera, X is a 3D point in a 3D scenario, x is a 2D projection of the 3D point on an image plane, F is a tangent plane of the 3D point, N(x) is a normal vector of a tangent plane where the 3D point is located, and D(x) is preliminary depth information corresponding to the 3D point. After the preliminarily completed depth image is obtained, the 2D projection x of the 3D point and the preliminary depth information corresponding to the 3D point may be obtained from the preliminarily completed depth image, and then a normal vector of the tangent plane where the 3D point is located may be obtained from the normal prediction map. Since the parameter matrix C is known, the 2D projection x of the 3D point, the preliminary depth information D(x) corresponding to the 3D point, the normal vector N(x) and the parameter matrix C may be substituted into the formula (1) to calculate the first plane origin distance of the 3D point. After the first plane origin distance of each 3D point in the 3D scenario is obtained by use of the formula (1), the first plane origin distance map may be obtained by determining the first plane origin distance of each 3D point as a pixel value.

In an embodiment of the disclosure, the preliminarily completed depth image, the feature map and the normal prediction map may be obtained based on the collected depth image and 2D image, the first plane origin distance map may be calculated based on the preliminarily completed depth image, the normal prediction map and the locally stored parameter matrix, and the diffused pixel value may be calculated for each pixel in the first plane origin distance map, so that the exceptional value in the first plane origin distance map may be cleared by use of the geometric constraint, the accuracy of the first plane origin distance map may be improved, and furthermore, a completed depth image with a better effect may be subsequently obtained based on the first plane origin distance map with higher accuracy.

In some embodiments of the disclosure, after the operation that the first plane origin distance map is calculated based on the preliminarily completed depth image, the parameter matrix of the video camera and the normal prediction map, i.e., S1023, the method may further include the following operations S1024 to S1026.

In S1024, a first confidence map is determined based on the collected depth image and 2D image, the first confidence map referring to an image taking a confidence of each pixel in the depth image as a pixel value.

In an embodiment of the disclosure, the first confidence map refers to an image obtained by determining a confidence of the preliminary depth information of each 3D point in the 3D scenario as a pixel value.

In S1025, a second plane origin distance map is calculated based on the collected depth image, the parameter matrix and the normal prediction map, the second plane origin distance map being an image taking a distance, calculated based on the collected depth image, from the video camera to the plane where each point in the 3D scenario is located as a pixel value.

In an embodiment of the disclosure, a second plane origin distance refers to a distance, calculated based on the depth image, from the center of the video camera to a tangent plane where a 3D point in the 3D scenario is located.

It is to be noted that, when the second plane origin distance map is calculated based on the depth image, the parameter matrix and a normal prediction result, the second plane origin distance of each 3D point in the 3D scenario is required to be calculated at first. When the second plane origin distance of each 3D point is calculated, a 2D projection of each 3D point on an image is required to be determined at first, an inversion operation may be executed on a parameter matrix to obtain an inverse matrix of the parameter matrix, then depth information corresponding to each 3D point may be acquired from the collected depth image, a normal vector of a tangent plane where each 3D point is located may be obtained from the normal prediction map, and then the depth information corresponding to each 3D point, the normal vector of the tangent plane where each 3D point is located, the inverse matrix of the parameter matrix and the 2D projection of the 3D point on the plane image may be multiplied to obtain the second plane origin distance of each 3D point.

Exemplarily, in an embodiment of the disclosure, the second plane origin distance of each 3D point may be calculated by use of the formula (5):

P̅(x)=D̅(x)N(x)C⁻¹x (5).

P̅(x) is a second plane origin distance of a 3D point, D(x) is depth information corresponding to the 3D point, N(x) is a normal vector of a tangent plane where the 3D point is located, x is a 2D projection of the 3D point on an image plane, and C is a parameter matrix of the video camera. After a value of the depth information of each 3D point, the normal vector of the tangent plane where each 3D point is located, the parameter matrix and the coordinate of the 2D projection of each 3D point on the image are acquired, the acquired data may be substituted into the formula (5) to calculate the second plane origin distance of each 3D point. Then, the second plane origin distance map may be obtained by determining the second plane origin distances of all the 3D points as pixel values.

In S1026, a pixel in the first plane origin distance map is optimized based on a pixel in the first confidence map, a pixel in the second plane origin distance map and the pixel in the first plane origin distance map to obtain an optimized first plane origin distance map.

It is to be noted that noise may be inevitably generated when the radar collects depth information of an edge of a moving target or object and consequently there may be some unreliable depth information in a collected depth image. Therefore, the first confidence map may be introduced to measure the reliability of depth information.

In an embodiment of the disclosure, the first confidence map refers to an image obtained by determining a confidence of depth information of each 3D point, i.e., the confidence of each pixel in the depth image, as a pixel value.

When the first plane origin distance map is optimized based on pixels in the first confidence map, pixels in the second plane origin distance map and pixels in the first plane origin distance map, the reliability of depth information of a 3D point corresponding to a certain pixel may be determined based on the pixel value of the pixel in the first confidence map. When a pixel value of a pixel in the first confidence map is relatively great, it is considered that the depth information of the 3D point corresponding to the pixel is relatively reliable, namely closer to a practical depth of the 3D point, and furthermore, the second plane origin distance of the 3D point corresponding to the pixel may be more reliable. In such case, if the first plane origin distance of the 3D point corresponding to the pixel is replaced with the second plane origin distance of the 3D point corresponding to the pixel for optimization, the optimized first plane origin distance map may include some pixels with pixel values closer to practical plane origin distances. Therefore, when pixel diffusion is implemented based on the optimized first plane origin distance map and the feature map, not only may exceptional values in the first plane origin distance map be cleared, but also the impact of exceptional values in the collected depth image on the optimized first plane origin distance map may be lowered. The accuracy of the optimized first plane origin distance map can be further improved.

In some embodiments of the disclosure, a value range may be set for a pixel value of the first confidence map to represent the reliability of original depth information. Exemplarily, the pixel value range of the first confidence map may be set to be [0, 1]. When a pixel value of the first confidence map is close to 1, it is indicated that original depth information of a 3D point corresponding to the corresponding pixel is reliable. When a pixel value of the first confidence map is closer to 0, it is indicated that original depth information of a 3D point corresponding to the corresponding pixel is unreliable. Of course, the pixel value range of the first confidence map may also be set based on a practical condition. No limits are made in the embodiments of the disclosure.

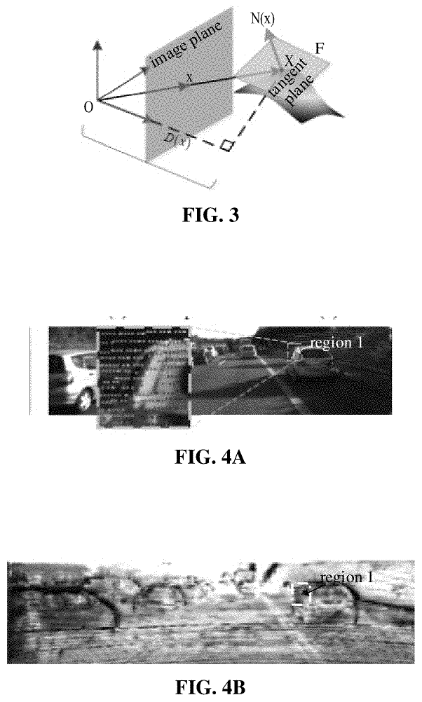

Exemplarily, an embodiment of the disclosure provides a schematic diagram of a noise of the collected depth image. As shown in FIG. 4A, when the radar collects depth information of an automobile in a motion state in region 1, there may be some noises, for example, the points in the small block are deviated, and consequently, the obtained depth information may be inconsistent with practical depth information, namely the depth information is unreliable. In such case, the reliability of the original depth information may be determined based on a pixel value of each pixel in the region 1 in FIG. 4B. It can be seen from FIG. 4B that the whole region 1 is relatively dark in color, and it is indicated that the region 1 includes a large number of pixels with pixel values close to 0, namely the region 1 includes a large number of pixels with unreliable depth information. During pixel replacement, replacement may be selected not to be performed based on a confidence condition of these pixels, thereby reducing the impact of these pixels on the optimized first plane origin distance map.

In an embodiment of the disclosure, a pixel with a reliable second plane origin distance may be selected from the second plane origin distance map based on the first confidence map, and the pixel value of a pixel corresponding to the pixel in the first plane origin distance map may be replaced to obtain the optimized first plane origin distance map, so that the completed depth image may be obtained based on the optimized first plane origin distance map. Therefore, not only may an exceptional value in the first plane origin distance map be cleared, but also the impact of an exceptional value in the depth image collected by the radar on the optimized first plane origin distance map may be reduced to improve the accuracy of the optimized first plane origin distance and further improve the accuracy of the completed depth image.

In some embodiments of the disclosure, an implementation process of the operation that the pixel in the first plane origin distance map is optimized based on the pixel in the first confidence map, the pixel in the second plane origin distance map and the pixel in the first plane origin distance map to obtain the optimized first plane origin distance map, i.e., S1026, may include the following operations S1026a to S1026e.

In S1026a, a pixel corresponding to a first pixel of the first plane origin distance map in the second plane origin distance map is determined as a replacing pixel, and a pixel value of the replacing pixel is determined, the first pixel being any pixel in the first plane origin distance map.

It is to be noted that, when the replacing pixel is determined, the second plane origin distance map is searched for a corresponding pixel based on coordinate information of the first pixel of the first plane origin distance map, and meanwhile, a pixel value of the corresponding pixel is acquired as a pixel value of the replacing pixel.

In S1026b, confidence information of the replacing pixel in the first confidence map is determined.

After the replacing pixel and the pixel value of the replacing pixel are determined, it is further needed to determine a pixel corresponding to the replacing pixel in the first confidence map according to coordinate information of the replacing pixel and acquire a pixel value of the pixel, i.e., confidence information of the pixel. In such a manner, the confidence information of the replacing pixel may be determined.

In S1026c, an optimized pixel value of the first pixel of the first plane origin distance map is determined based on the pixel value of the replacing pixel, the confidence information and a pixel value of the first pixel of the first plane origin distance map.

It is to be noted that, when the optimized pixel value of the first pixel of the first plane origin distance map is calculated, whether the pixel value of the replacing pixel is greater than 0 or not may be judged at first. A judgment result may be recorded by use of a truth function. Namely, a function value of the truth function is 1 when the pixel value of the replacing pixel is greater than 0, and the function value of the truth function is 0 when the pixel value of the replacing pixel is less than or equal to 0. Then the optimized value of the first pixel may be calculated based on the function value of the truth function, the pixel value of the replacing pixel, the confidence information and the pixel value of the first pixel of the first plane origin distance map.

In an embodiment of the disclosure, the function value of the truth function may be multiplied by the confidence information and the pixel value of the replacing pixel to obtain a first sub optimized pixel value. Meanwhile, the function value of the truth function may be multiplied by the confidence information, a difference between 1 and an obtained product may be calculated, and the difference may be multiplied by the pixel value of the first pixel of the first plane origin distance map to obtain a second sub optimized pixel value. Finally, the first sub optimized pixel value and the second sub optimized pixel value may be added to obtain the optimized pixel value of the first pixel. It is to be noted that a preset distance calculation model may also be set in another manner No limits are made in the embodiments of the disclosure.

Exemplarily, an embodiment of the disclosure provides a formula for calculating the optimized pixel value of the first pixel based on the function value of the truth function, the pixel value of the replacing pixel, the confidence information and the pixel value of the first pixel of the first plane origin distance map, as shown in the formula (6):

P′(xᵢ)=F[P̅(xᵢ)>0]M(xᵢ)P̅(xᵢ)+(1−F[P̅(xᵢ)>0]M(xᵢ))P(xᵢ) (6).

F[P̅(xᵢ)>0] is the truth function, M(xᵢ) is the confidence information of the replacing pixel, P̅(xᵢ) is the pixel value of the replacing pixel, P(xᵢ) is the pixel value of the first pixel of the first plane origin distance map, and P′(xᵢ) is the optimized pixel value of the first pixel of the first plane origin distance map.

In S1026d, the foregoing operations are repeated until optimized pixel values of all pixels of the first plane origin distance map are determined to obtain the optimized first plane origin distance map.

An optimized pixel value may be calculated for each pixel in the first plane origin distance map according to the calculation method for the optimized pixel value of the first pixel of the first plane origin distance map in the above operations, and the optimized first plane origin distance map may be obtained by use of these optimized pixel values.

In an embodiment of the disclosure, the optimized pixel values of the pixels in the first plane origin distance map may be calculated one by one to obtain the optimized first plane origin distance map, so that a diffusion intensity of each pixel of the optimized first plane origin distance map may be subsequently determined based on the optimized first plane origin distance map and the feature map, and a completed depth image with a better effect may be obtained based on the diffusion intensities and the pixel values of the optimized first plane origin distance map.

In some embodiments of the disclosure, referring to FIG. 5, an implementation process of the operation that the diffusion intensity of each pixel in the to-be-diffused map is determined based on the to-be-diffused map and the feature map, i.e., S103, may include the following operations S1031 to S1032.

In S1031, a to-be-diffused pixel set corresponding to a second pixel of the to-be-diffused map in the to-be-diffused map is determined based on a preset diffusion range, and a pixel value of each pixel in the to-be-diffused pixel set is determined, the second pixel being any pixel in the to-be-diffused map.

It is to be noted that the to-be-diffused pixel set refers to pixels in a neighborhood of the second pixel of the to-be-diffused map. A neighborhood range of the second pixel of the to-be-diffused map is determined at first based on the preset diffusion range, and then all pixels in the neighborhood range may be extracted to form the to-be-diffused pixel set corresponding to the second pixel of the to-be-diffused map.

In some embodiments of the disclosure, the preset diffusion range may be set according to a practical requirement. No limits are made in the embodiments of the disclosure. Exemplarily, the preset diffusion range may be set to be four neighborhoods, and four pixels are extracted to form the to-be-diffused pixel set. Or, the preset diffusion range may be set to be eight neighborhoods, and eight pixels around the second pixel of the to-be-diffused map are extracted to form the to-be-diffused pixel set.

In S1032, a diffusion intensity of the second pixel of the to-be-diffused map is calculated based on the feature map, the second pixel of the to-be-diffused map and each pixel in the to-be-diffused pixel set.

Feature information corresponding to the second pixel of the to-be-diffused map and feature information corresponding to each pixel in the to-be-diffused pixel set may be acquired from the feature map, and the diffusion intensity of the second pixel of the to-be-diffused map may be calculated based on the feature information.

It is to be noted that, since the to-be-diffused pixel set consists of multiple pixels, when the diffusion intensity of the second pixel of the to-be-diffused map is calculated, the second pixel of the to-be-diffused map and pixels in the to-be-diffused pixel set may form pixel pairs respectively, sub diffusion intensities of these pixel pairs may be calculated respectively, and then all the sub diffusion intensities may be determined as the diffusion intensity of the second pixel of the to-be-diffused map.

After the diffusion intensity of the second pixel of the to-be-diffused map is obtained, the following S1033 to S1034 may be executed based on the pixel value of each pixel in the to-be-diffused map and the diffused pixel value of each pixel in the to-be-diffused map.

In S1033, a diffused pixel value of the second pixel of the to-be-diffused map is determined based on the diffusion intensity of the second pixel of the to-be-diffused map, a pixel value of the second pixel of the to-be-diffused map and the pixel value of each pixel in the to-be-diffused pixel set.

After the diffusion intensity of the second pixel of the to-be-diffused map is obtained, the operation that the diffused pixel value of each pixel in the to-be-diffused map is determined based on the pixel value of each pixel in the to-be-diffused map and the diffusion intensity of each pixel in the to-be-diffused map may be replaced with the operation that the diffused pixel value of the second pixel of the to-be-diffused map is determined based on the diffusion intensity of the second pixel of the to-be-diffused map, the pixel value of the second pixel of the to-be-diffused map and the pixel value of each pixel in the to-be-diffused pixel set.

In S1034, the operation is repeated until the diffused pixel values of all pixels in the to-be-diffused map are determined.

Exemplarily, an embodiment of the disclosure provides a diagram of the method for depth image completion. As shown in FIG. 6, in the example, the preliminarily completed depth image is determined as the to-be-diffused map. A depth image D̅ is collected through the radar, meanwhile, a 2D image I of a 3D scenario is collected through the video camera, D̅ and I are input to a preset prediction model 1 to obtain a preliminarily completed depth image D and a feature map G, then a diffusion intensity 2 of each pixel in the preliminarily completed depth image D is determined based on the preliminarily completed depth image D and the feature map G, and a diffused pixel value of each pixel in the preliminarily completed depth image D is obtained based on a pixel value of each pixel in the preliminarily completed depth image D and the diffusion intensity 2, thereby obtaining a completed depth image Dᵣ.

It can be understood that, after diffused pixel values of the first plane origin distance map are calculated when the first plane origin distance map is determined as the to-be-diffused map, a diffused first plane origin distance map may be obtained, but the diffused first plane origin distance map is not the completed depth image and it is further necessary to perform inverse transformation on the diffused first plane origin distance map to obtain the completed depth image.

In an embodiment of the disclosure, since the first plane origin distance map is calculated based on the preliminarily completed depth image, the normal prediction map and the parameter matrix, a depth image may be inversely calculated based on the diffused first plane origin distance map, the normal prediction map and the parameter matrix, and the calculated depth image is determined as the completed depth image.

In an embodiment of the disclosure, a normal vector of a tangent plane where each 3D point is located and a 2D projection of each 3D point on an image plane may be acquired from the normal prediction map, a diffused first plane origin distance of each 3D point may be acquired from the diffused first plane origin distance map, meanwhile, inversion may be performed on a parameter matrix to obtain an inverse matrix of the parameter matrix, then the normal vector of the tangent plane where each 3D point is located, the 2D projection of each 3D point on the image plane and the inverse matrix of the parameter matrix may be multiplied to obtain a product result, a ratio of the diffused first plane origin distance to the obtained product result may be calculated as depth completion information corresponding to each 3D point, and then the completed depth image may be obtained by determining the depth completion information corresponding to each 3D point as a pixel value.

Exemplarily, an embodiment of the disclosure provides a process of calculating the depth completion information corresponding to each 3D point, as shown in the formula (7):

$${D}^{′} ( x ) = \frac{{P}_{1} ( x )}{N ( x ) {C}^{- 1} x} . \qquad ( 7 )$$

D′(x) represents depth completion information corresponding to each 3D point, P₁(x) represents a diffused first plane origin distance of a 3D point, x represents a 2D projection of the 3D point on an image plane, N(x) represents a normal vector of a tangent plane where the 3D point x is located, and C represents a parameter matrix.

After a normal vector of a tangent plane where each 3D point is located, a coordinate of a 2D projection of each 3D point on an image plane, a parameter matrix and a numerical value of a diffused first plane origin distance of each 3D point may be obtained, these parameters may be substituted into the formula (7) to calculate the depth completion information corresponding to each 3D point, thereby obtaining the completed depth image based on the depth completion information corresponding to each 3D point.

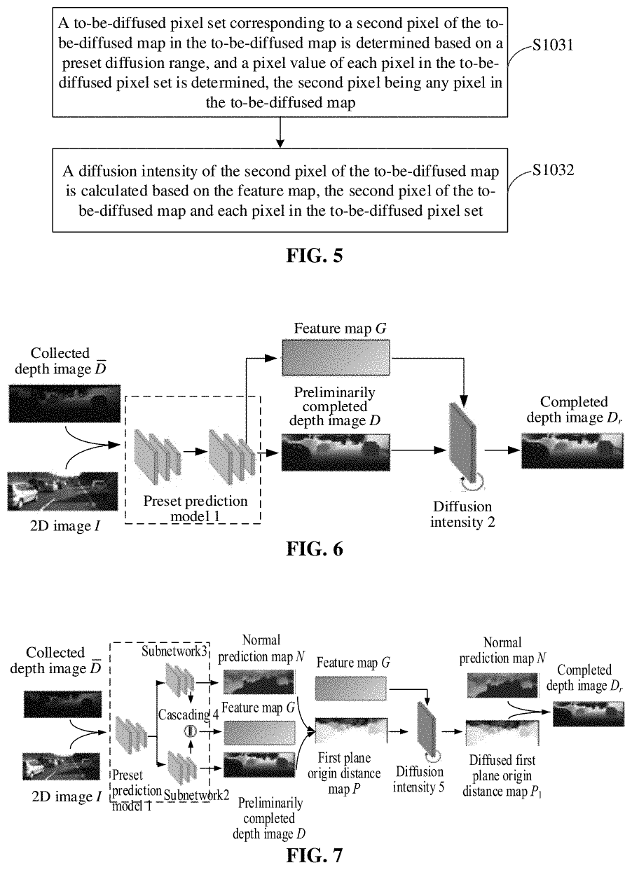

Exemplarily, referring to FIG. 7, a process of the method for depth image completion is illustrated in an embodiment of the disclosure. In the example, the first plane origin distance map is determined as the to-be-diffused map. A collected depth image D̅ and 2D image I are input to a preset prediction model 1 to obtain a preliminarily completed depth image D output by a subnetwork 2 configured to output the preliminarily completed depth image and a normal prediction map N output by a subnetwork 3 configured to predict a normal map. Meanwhile, cascading 4 is performed on the subnetwork 2 configured to output the preliminarily completed depth image and the subnetwork 3 configured to predict the normal map by use of a convolutional layer, and feature data in the convolutional layer is visualized to obtain a feature map G. Then, a first plane origin distance corresponding to each 3D point in the 3D scenario is calculated by use of the formula (1) based on the preliminarily completed depth image D, the normal prediction map N and an acquired parameter matrix C to further obtain a first plane origin distance map P. Finally, a diffusion intensity 5 of each pixel in the first plane origin distance map P is determined based on the obtained first plane origin distance map P and the feature map G, a diffused pixel value of each pixel in the first plane origin distance map P is obtained based on a pixel value of each pixel in the first plane origin distance map P and the diffusion intensity 5 to obtain a diffused first plane origin distance map P₁, and inverse transformation is performed on the diffused first plane origin distance map P₁ and the normal prediction map N by use of the formula (7) to obtain a completed depth image Dᵣ.

Similarly, when the optimized first plane origin distance map is determined as the to-be-diffused map, diffused pixel values may be calculated to obtain a diffused optimized first plane origin distance map, and then it is necessary to perform inverse transformation on the diffused optimized first plane origin distance map to obtain a completed depth image.

In an embodiment of the disclosure, a plane origin distance of each 3D point may be acquired from the diffused optimized first plane origin distance map. A normal vector of a tangent plane where each 3D point is located and a 2D projection of each 3D point on an image plane may be acquired from the normal prediction map, meanwhile, an inverse matrix of a parameter matrix may be calculated. Then the normal vector of the tangent plane where each 3D point is located, the 2D projection of each 3D point on the image plane and the inverse matrix of the parameter matrix may be multiplied to obtain a product result, a ratio of the plane origin distance of each 3D point to the product result may be calculated as depth completion information corresponding to each 3D point, and finally, the completed depth image may be obtained by determining the depth completion information corresponding to each 3D point as a pixel.

Exemplarily, in an embodiment of the disclosure, the depth completion information corresponding to each 3D point may be calculated by use of the formula (8):

$${D}^{′} ( x ) = \frac{{P}_{1}^{′} ( x )}{N ( x ) {C}^{- 1} x} . \qquad ( 8 )$$

D′(x) is depth completion information corresponding to a 3D point, P′₁ (x) is a plane origin distance, obtained by pixel diffusion, of the 3D point, N(x) is a normal vector of a tangent plane where the 3D point is located, x is a 2D projection of the 3D point on an image plane, and C is a parameter matrix of the video camera.

After a specific numerical value of a plane origin distance of a 3D point, a normal vector of a tangent plane where the 3D point is located and a coordinate of a 2D projection of the 3D point on an image plane are acquired, these parameters may be substituted into the formula (8) to obtain depth completion information corresponding to each 3D point, and a completed depth image may further be obtained by determining the depth completion information corresponding to each 3D point as a pixel value.

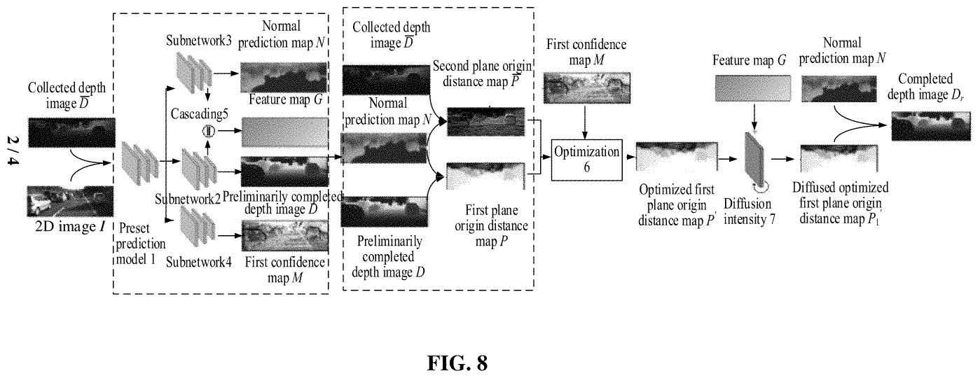

Exemplarily, a process of the method for depth image completion is illustrated in an embodiment of the disclosure. As shown in FIG. 8, a collected depth image D̅ and 2D image I are input to a preset prediction model 1 to obtain a preliminarily completed depth image D output by a subnetwork 2 configured to output the preliminarily completed depth image, a normal prediction map N output by a subnetwork 3 configured to predict a normal map and a first confidence map M output by a subnetwork 4 configured to output the first confidence map. Meanwhile, cascading 5 is performed on the subnetwork 2 configured to output the preliminarily completed depth image and the subnetwork 3 configured to predict the normal map by use of a convolutional layer, and feature data in the convolutional layer is visualized to obtain a feature map G. Then, a first plane origin distance of each 3D point is calculated by use of the formula (4) and the obtained preliminarily completed depth image D, normal prediction map N and parameter matrix C to further obtain a first plane origin distance map P. Meanwhile, a second plane origin distance of each 3D point is calculated by use of the formula (5), the depth image D̅ collected by the radar, the normal prediction map N and the parameter matrix C to further obtain a second plane origin distance map P̅. Next, a pixel with a reliable second plane origin distance may be selected based on the first confidence map M, corresponding optimization 6 may be performed on each pixel in the first plane origin distance map P based on the reliable second plane origin distance to obtain an optimized first plane origin distance map P′, a diffusion intensity 7 of each pixel in P′ may be obtained based on the optimized first plane origin distance map P′ and the feature map G, and a diffused pixel value of each pixel in the optimized first plane origin distance map P′ may be obtained based on the pixel value of each pixel in the optimized first plane origin distance map P′ and the diffusion intensity 7 to obtain a diffused optimized first plane origin distance map P′₁. Finally, inverse transformation may be performed on the diffused optimized first plane origin distance map P′₁ and the normal prediction map N by use of the formula (8) to obtain depth completion information of each 3D point to further obtain a completed depth image.

In an embodiment of the disclosure, a corresponding to-be-diffused pixel set may be determined for each pixel of the to-be-diffused map based on a preset diffusion range, and furthermore, the diffusion intensity of each pixel of the to-be-diffused map may be calculated based on the feature map, each pixel of the to-be-diffused map and the to-be-diffused pixel set corresponding to each pixel of the to-be-diffused map, so that the diffused pixel value of each pixel in the to-be-diffused map may be calculated based on the diffusion intensity, the pixel value of each pixel of the to-be-diffused map and the to-be-diffused pixel set corresponding to each pixel of the to-be-diffused map to obtain a completed depth image.

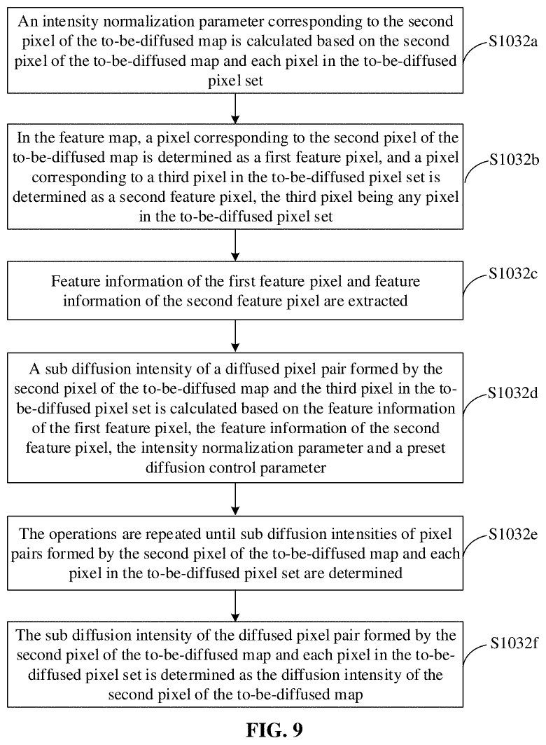

In some embodiments of the disclosure, as shown in FIG. 9, an implementation process of the operation that the diffusion intensity of the second pixel of the to-be-diffused map is calculated based on the feature map, the second pixel of the to-be-diffused map and each pixel in the to-be-diffused pixel set, i.e., S1032, may include the following operations S1032a to S1032f.

In S1032a, an intensity normalization parameter corresponding to the second pixel of the to-be-diffused map is calculated based on the second pixel of the to-be-diffused map and each pixel in the to-be-diffused pixel set.

When the diffusion intensity of the second pixel of the to-be-diffused map is calculated, a preset feature extraction model that is set in advance may be adopted at first to perform feature extraction on the second pixel of the to-be-diffused map and perform feature extraction on each pixel in the to-be-diffused pixel set determined by the preset diffusion range, and then the intensity normalization parameter corresponding to the second pixel of the to-be-diffused map may be calculated based on extracted feature information to subsequently obtain the diffusion intensity of the second pixel of the to-be-diffused map by use of the intensity normalization parameter.

It is to be noted that the intensity normalization parameter is a parameter configured to normalize results calculated for feature information of a first feature pixel and feature information of a second feature pixel to obtain a sub diffusion intensity.

It can be understood that a small convolution kernel may be adopted as the preset feature extraction model, for example, a 1×1 convolution kernel. Or, another machine learning model capable of achieving the same purpose may be adopted as the preset feature extraction model. No limits are made in the embodiments of the disclosure.

It is to be noted that, since the second pixel of the to-be-diffused map and each pixel in the to-be-diffused pixel set are processed by the preset feature extraction model, namely at least two types of pixels may be processed by the preset feature extraction model, feature extraction may be performed on the second pixel of the to-be-diffused map and each pixel in the to-be-diffused pixel set by the same preset feature extraction model. Feature extraction may also be performed on the second pixel of the to-be-diffused map and each pixel in the to-be-diffused pixel set by different preset feature extraction models respectively.

In S1032b, in the feature map, a pixel corresponding to the second pixel of the to-be-diffused map is determined as a first feature pixel, and a pixel corresponding to a third pixel in the to-be-diffused pixel set is determined as a second feature pixel, the third pixel being any pixel in the to-be-diffused pixel set.

After the intensity normalization parameter of the second pixel of the to-be-diffused map is calculated, the feature map may be searched for a pixel corresponding to the second pixel of the to-be-diffused map, and the found pixel is determined as the first feature pixel. Meanwhile, the feature map may be searched for a pixel corresponding to the third pixel in the to-be-diffused pixel set, and the found pixel is determined as the second feature pixel. The third pixel may be any pixel in the to-be-diffused pixel set.

It is to be noted that, since the feature map is an image obtained by visualizing feature data of a certain layer in the preset prediction model, for finding the pixel corresponding to the second pixel of the to-be-diffused map in the feature map, a convolutional layer with the same size as the to-be-diffused map may be selected from the preset prediction model, feature data in the convolutional layer may be visualized to obtain the feature map, so that pixels of the feature map correspond to pixels of the to-be-diffused map one to one. Furthermore, the first feature pixel may be found based on position information of the second pixel of the to-be-diffused map. Similarly, the second feature pixel may be found based on position information of the third pixel in the to-be-diffused pixel set. Of course, a device may also search for the first feature pixel and the second feature pixel in another manner No limits are made in the embodiments of the disclosure.

In S1032c, feature information of the first feature pixel and feature information of the second feature pixel are extracted.

In an embodiment of the disclosure, when the feature information of the first feature pixel is extracted, a pixel value of the first feature pixel is extracted at first, and then the pixel value of the first feature pixel is operated by the preset feature extraction model to obtain the feature information of the first feature pixel. Similarly, when the feature information of the second feature pixel is extracted, a pixel value of the second feature pixel is extracted at first, and then the pixel value of the second feature pixel is operated by the preset feature extraction model to obtain the feature information of the second feature pixel.

Exemplarily, feature extraction may be performed on the first feature pixel by a preset feature extraction model f, and extraction may be performed on the second feature pixel by a preset feature extraction model g. The first feature pixel is a pixel corresponding to the second pixel of the to-be-diffused map in the feature map and may be represented as G(xᵢ). The second feature pixel is a pixel corresponding to the third pixel in the to-be-diffused pixel set in the feature map and may be represented as G(xᵢ). Correspondingly, the feature information of the first feature pixel is f(G(xᵢ)), and the feature information of the second feature pixel is g(G(xᵢ)). Therefore, the feature information of the first feature pixel and the feature information of the second feature pixel are obtained.

In S1032d, a sub diffusion intensity of a diffused pixel pair formed by the second pixel of the to-be-diffused map and the third pixel in the to-be-diffused pixel set is calculated based on the feature information of the first feature pixel, the feature information of the second feature pixel, the intensity normalization parameter and a preset diffusion control parameter.

In an embodiment of the disclosure, the preset diffusion control parameter is a parameter configured to control a sub diffusion intensity value. The preset diffusion control parameter may be a fixed value set according to the practical requirement or may also be a variable parameter capable of learning.

In an embodiment of the disclosure, through a preset diffusion intensity calculation model, the feature information of the first feature pixel may be transposed to obtain a transposition result, then the transposition result may be multiplied by the feature information of the second feature pixel, a difference between 1 and an obtained product may be calculated to obtain a difference result, then the difference result may be squared, a ratio of a square and a multiple of a square of the preset diffusion control parameter may be calculated, then an operation may be executed by taking the obtained ratio as an exponent of an exponential function and taking a natural logarithm e as a base number of the exponential function, and finally, an obtained calculation result may be normalized by use of the intensity normalization parameter to obtain the final sub diffusion intensity. It is to be noted that a specific form of the preset diffusion intensity calculation model may be set according to the practical requirement. No limits are made in the embodiments of the disclosure.

Exemplarily, an embodiment of the disclosure provides a preset diffusion intensity calculation model, as shown in the formula (9):

$$w ( {x}_{i} , {x}_{j} ) = \frac{1}{S ( {x}_{i} )} exp ( - \frac{{( 1 - {f ( G ( {x}_{i} ) )}^{T} g ( G ( {x}_{j} ) ) )}^{2}}{2 {σ}^{2}} ) . \qquad ( 9 )$$

xᵢ represents the second pixel of the to-be-diffused map, xⱼ represents the third pixel in the to-be-diffused pixel set, S(xᵢ) represents the intensity normalization parameter corresponding to the second pixel of the to-be-diffused map, G(xᵢ) represents the first feature pixel, G(xᵢ) represents the second feature pixel, f(G(xᵢ)) represents the feature information of the first feature pixel, g(G(xᵢ)) represents the feature information of the second feature pixel, σ represents the preset diffusion control parameter, and w(xᵢ,xⱼ) represents the sub diffusion intensity corresponding to the diffused pixel pair formed by the second pixel of the to-be-diffused map and the third pixel in the to-be-diffused pixel set.

After the feature information f(G(xᵢ)) of the first feature pixel and the feature information g(G(xⱼ)) of the second feature pixel are obtained and the intensity normalization parameter S(xᵢ) corresponding to the second pixel of the to-be-diffused map is calculated, specific numerical values of these parameters may be substituted into the formula (9) to calculate the sub diffusion intensity w(xᵢ,xⱼ) of the diffused pixel pair formed by the second pixel of the to-be-diffused map and the third pixel in the to-be-diffused pixel set.

In S1032e, the foregoing operations are repeated until sub diffusion intensities of pixel pairs formed by the second pixel of the to-be-diffused map and each pixel in the to-be-diffused pixel set are determined.

In S1032f, a sub diffusion intensity of a diffused pixel pair formed by the second pixel of the to-be-diffused map and each pixel in the to-be-diffused pixel set is determined as the diffusion intensity of the second pixel of the to-be-diffused map.

In an embodiment of the disclosure, a sub diffusion intensity of a diffused pixel pair formed by the second pixel of the to-be-diffused map and each pixel in the to-be-diffused pixel set may be calculated, and then all the calculated sub diffusion intensities are determined as the diffusion intensity of the second pixel of the to-be-diffused map. In such a manner, the diffusion intensity of each pixel in the to-be-diffused map may be obtained, and a diffused pixel value may be calculated for each pixel in the to-be-diffused map based on the diffusion intensity, thereby obtaining a completed depth image with higher accuracy.

In some embodiments of the disclosure, the sub diffusion intensity may be a similarity between the second pixel of the to-be-diffused map and the third pixel in the to-be-diffused pixel set.

In an embodiment of the disclosure, the similarity between the second pixel of the to-be-diffused map and the third pixel in the to-be-diffused pixel set may be determined as a sub diffusion intensity, namely an intensity of diffusion of the third pixel in the to-be-diffused pixel set to the second pixel of the to-be-diffused map may be determined based on the similarity between the second pixel of the to-be-diffused and the third pixel in the to-be-diffused pixel set. When the second pixel of the to-be-diffused map is relatively similar to the third pixel in the to-be-diffused pixel set, it is considered that the second pixel of the to-be-diffused map and the third pixel in the to-be-diffused pixel set are on the same plane in the 3D scenario at a high possibility, and in such case, the intensity of diffusion of the third pixel in the to-be-diffused pixel set to the second pixel of the to-be-diffused map may be higher. When the second pixel of the to-be-diffused map is dissimilar to the third pixel in the to-be-diffused pixel set, it indicates the second pixel of the to-be-diffused map and the third pixel in the to-be-diffused pixel set are on different planes, and in such case, the intensity of diffusion of the third pixel in the to-be-diffused pixel set to the second pixel of the to-be-diffused map may be relatively low to avoid an error in a pixel diffusion process.

In an embodiment of the disclosure, the sub diffusion intensity may be determined based on the similarity between a pixel in the to-be-diffused map and each pixel in the to-be-diffused pixel set to ensure that a diffused pixel value may be calculated for each pixel in the to-be-diffused map based on pixels on the same plane as pixels in the to-be-diffused map to obtain a completed depth image with higher accuracy.

In some embodiments of the disclosure, an implementation of the operation that the intensity normalization parameter corresponding to the second pixel of the to-be-diffused map is calculated based on the second pixel of the to-be-diffused map and each pixel in the to-be-diffused pixel set, i.e., S1032a, may include the following S201 to S204.

In S201, feature information of the second pixel of the to-be-diffused map and feature information of the third pixel in the to-be-diffused pixel set are extracted.

It is to be noted that, when the feature information of the second pixel of the to-be-diffused map is extracted by the preset feature extraction model, a pixel value of the second pixel of the to-be-diffused map is acquired at first, and then the pixel value is calculated by the preset feature extraction model to obtain the feature information of the second pixel of the to-be-diffused map. Similarly, when the feature information of the third pixel in the to-be-diffused pixel set is extracted, a pixel value of the third pixel in the to-be-diffused pixel set is acquired at first, and then the pixel value is calculated by the preset feature extraction model to obtain the feature information of the third pixel in the to-be-diffused pixel set.

Exemplarily, when the second pixel of the to-be-diffused map is represented as xᵢ and the third pixel in the to-be-diffused pixel set is represented as xⱼ, if feature extraction is performed on the second pixel of the to-be-diffused map by the preset feature extraction model f and feature extraction is performed on the third pixel in the to-be-diffused pixel set by the preset feature extraction model g, the feature information of the second pixel of the to-be-diffused map may be represented as f(xᵢ), and the feature information of the third pixel in the to-be-diffused pixel set may be represented as g(xᵢ). Of course, feature extraction may also be performed on the second pixel of the to-be-diffused map and the third pixel in the to-be-diffused pixel set by use of another preset feature extraction model. No limits are made in the embodiments of the disclosure.

In S202, a sub normalization parameter of the third pixel in the to-be-diffused pixel set is calculated based on the extracted feature information of the second pixel of the to-be-diffused map and feature information of the third pixel in the to-be-diffused pixel set and the preset diffusion control parameter.

It is to be noted that, through a preset sub normalization parameter calculation model, matrix transposition is performed on the feature information of the second pixel of the to-be-diffused map, and a transposition result is then multiplied by the feature information of the third pixel in the to-be-diffused pixel set. Then a difference between 1 and an obtained product result is calculated, and an obtained difference result is squared to obtain a square result. Next, a ratio of the square result to a multiple of the square of the preset diffusion control parameter is calculated. Finally, a calculation is executed by taking the obtained ratio as an exponent of an exponential function and taking the natural logarithm e as a base number of the exponential function, and a final calculation result is determined as the sub normalization parameter corresponding to the third pixel in the to-be-diffused pixel set. Of course, the preset sub normalization parameter calculation model may also be set in another form according to a practical requirement. No limits are made in the embodiments of the disclosure.

Exemplarily, an embodiment of the disclosure provides a preset sub normalization parameter calculation model, referring to the formula (10):

$$s ( {x}_{j} ) = exp ( - \frac{{( 1 - {f ( {x}_{i} )}^{T} g ( {x}_{j} ) )}^{2}}{2 {σ}^{2}} ) . \qquad ( 10 )$$

xᵢ represents the second pixel of the to-be-diffused map, xⱼ represents the third pixel in the to-be-diffused pixel set, f(xᵢ) represents the feature information of the second pixel of the to-be-diffused map, g(xᵢ) represents the feature information of the third pixel in the to-be-diffused pixel set, σ represents the preset diffusion control parameter, and s(xⱼ) represents the sub normalization parameter corresponding to the third pixel in the to-be-diffused pixel set.

After the feature information f(xᵢ) of the second pixel of the to-be-diffused map and the feature information g(xⱼ) of the third pixel in the to-be-diffused pixel set are obtained and the preset diffusion control parameter σ is acquired, the specific numerical values of these parameters may be substituted into the formula (10) to calculate the sub normalization parameter corresponding to the third pixel in the to-be-diffused pixel set.

In S203, the foregoing operations are repeated until sub normalization parameters of all pixels of the to-be-diffused pixel set are obtained.

In S204, the sub normalization parameters of all pixels of the to-be-diffused pixel set are accumulated to obtain the intensity normalization parameter corresponding to the second pixel of the to-be-diffused map.

Exemplarily, when the sub normalization parameter of the third pixel in the to-be-diffused pixel set is s(xⱼ), the intensity normalization parameter corresponding to the second pixel of the to-be-diffused map may be obtained by use of the formula (11):

S(xᵢ)=Σ_{j∈N}_{ᵢ}s(xⱼ) (11).

Nᵢ represents the to-be-diffused pixel set, and s(xᵢ) represents the intensity normalization parameter of the second pixel of the to-be-diffused map.

When numerical values of sub normalization parameters of pixels in the to-be-diffused pixel set are calculated, the numerical values of these sub normalization parameters may be substituted into the formula (11) for accumulation, and an obtained accumulation result is determined as the intensity normalization parameter corresponding to the second pixel of the to-be-diffused map.

In an embodiment of the disclosure, at first, feature extraction is performed on the second pixel of the to-be-diffused map, and feature extraction is performed on each pixel in the to-be-diffused pixel set. Then, calculation is performed on extracted feature information and the preset diffusion control parameter by the preset sub normalization parameter calculation model to obtain the sub normalization parameters, and all the obtained sub normalization parameters are accumulated to obtain the intensity normalization parameter, so that the diffusion intensity may subsequently be calculated by use of the intensity normalization parameter.

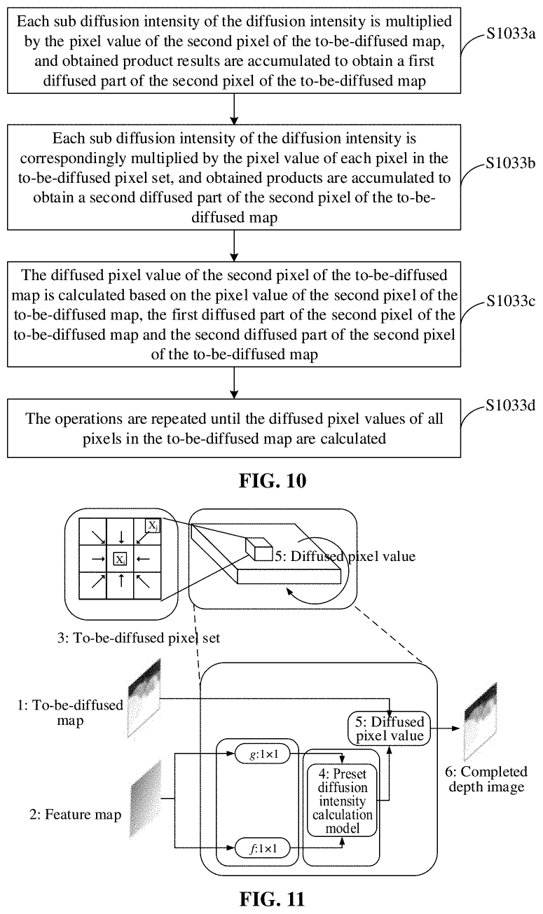

In some embodiments of the disclosure, as shown in FIG. 10, an implementation process of the operation that the diffused pixel value of the second pixel of the to-be-diffused map is determined based on the diffusion intensity of the second pixel of the to-be-diffused map, the pixel value of the second pixel of the to-be-diffused map and the pixel value of each pixel in the to-be-diffused pixel set, i.e., S1033, may include the following operations S1033a to S1033d.

In S1033a, each sub diffusion intensity of the diffusion intensity is multiplied by the pixel value of the second pixel of the to-be-diffused map, and obtained product results are accumulated to obtain a first diffused part of the second pixel of the to-be-diffused map.

In an embodiment of the disclosure, the pixel value of the second pixel of the to-be-diffused map and the diffusion intensity of the second pixel of the to-be-diffused map are acquired at first, and the sub diffusion intensity of the third pixel in the to-be-diffused pixel set in the diffusion intensity of the second pixel of the to-be-diffused map is multiplied by the pixel value of the second pixel of the to-be-diffused map to obtain a product result. Such operations are repeated until the pixel value of the second pixel of the to-be-diffused map is multiplied by sub diffusion intensities of each pixel in the to-be-diffused pixel set. All obtained products are accumulated to calculate the first diffused part of the second pixel of the to-be-diffused map.

It is to be noted that, in an embodiment of the disclosure, the first diffused part of the second pixel of the to-be-diffused map may also be calculated in another manner No limits are made in the embodiments of the disclosure.

Exemplarily, in an embodiment of the disclosure, the first diffused part may be calculated by use of the formula (12). The formula (12) is as follows:

p₁(xᵢ)=Σₓ_{ⱼ}_{∈N(x}_{ᵢ}₎w(xᵢ,xⱼ)P(xᵢ) (12).

w(xᵢ,xⱼ) is the sub diffusion intensity corresponding to the third pixel in the to-be-diffused pixel set, N(xᵢ) represents the to-be-diffused pixel set, P(xᵢ) represents the pixel value of the second pixel of the to-be-diffused map, and p₁(xᵢ) represents the calculated first diffused part of the second pixel of the to-be-diffused map.

After the pixel value of the second pixel of the to-be-diffused map and the numerical value of the sub diffusion intensity of each pixel in the to-be-diffused pixel set are obtained, the pixel value of the second pixel of the to-be-diffused map and the numerical value of the sub diffusion intensity of each pixel in the to-be-diffused pixel set may be substituted into the formula (12) to calculate the first diffused part of the second pixel of the to-be-diffused map.

It is to be noted that, since the sub diffusion intensities are normalized by use of the intensity normalization parameter when the diffusion intensity of the second pixel of the to-be-diffused map is calculated, a numerical value of an accumulation result obtained by accumulating products of all sub diffusion intensities multiplied by the pixel value of the second pixel of the to-be-diffused map may not exceed the original pixel value of the second pixel of the to-be-diffused map.

In S1033b, each sub diffusion intensity of the diffusion intensity is multiplied by the pixel value of each pixel in the to-be-diffused pixel set, and obtained products are accumulated to obtain a second diffused part of the second pixel of the to-be-diffused map.

It is to be noted that, when the sub diffusion intensities are multiplied by each pixel value in the to-be-diffused pixel set, the sub diffusion intensity corresponding to the third pixel in the to-be-diffused pixel set is multiplied by the pixel value of the third pixel in the to-be-diffused pixel set at first to obtain a product result. Such an operation is repeated until all sub diffusion intensities are multiplied by all pixel values in the to-be-diffused pixel set. Finally, all the products are accumulated, and an obtained accumulation result is determined as the second diffused part of the second pixel of the to-be-diffused map.

It is to be noted that, in an embodiment of the disclosure, the second diffused part of the second pixel of the to-be-diffused map may also be calculated in another method. No limits are made in the embodiments of the disclosure.

Exemplarily, in an embodiment of the disclosure, the second diffused part may be calculated by use of the formula (13):

p₂(xᵢ)=Σₓ_{ⱼ}_{∈N(x}_{ᵢ}₎w(xᵢ,xⱼ)P(xⱼ) (13).

w(xᵢ,xⱼ) is the sub diffusion intensity corresponding to the third pixel in the to-be-diffused pixel set, N(xᵢ) represents the to-be-diffused pixel set, P(xⱼ) represents the pixel value of the third pixel in the to-be-diffused pixel set, and p₂(xᵢ) represents the calculated second diffused part of the second pixel of the to-be-diffused map.

After the pixel value of the third pixel in the to-be-diffused pixel set and the numerical value of the sub diffusion intensity of each pixel in the to-be-diffused pixel set are obtained, the pixel value of the third pixel in the to-be-diffused pixel set and the numerical value of the sub diffusion intensity of each pixel in the to-be-diffused pixel set may be substituted into the formula (13) to calculate the second diffused part of the second pixel of the to-be-diffused map.

In S1033c, the diffused pixel value of the second pixel of the to-be-diffused map is calculated based on the pixel value of the second pixel of the to-be-diffused map, the first diffused part of the second pixel of the to-be-diffused map and the second diffused part of the second pixel of the to-be-diffused map.

In an embodiment of the disclosure, the first diffused pixel part may be subtracted from the pixel value of the second pixel of the to-be-diffused map, then an obtained difference and the second diffused part are added, and a final addition result is determined as the diffused pixel value. It is to be noted that, in an embodiment of the disclosure, other processing may also be performed on the pixel value of the second pixel of the to-be-diffused map, the first diffused pixel part and the second diffused pixel part to obtain the diffused pixel value of the second pixel of the to-be-diffused map. No limits are made in the embodiments of the disclosure.

Exemplarily, in an embodiment of the disclosure, the diffused pixel value of the second pixel of the to-be-diffused map may be obtained according to the formula (14) to complete pixel diffusion:

P(xᵢ)←(1−Σₓ_{ⱼ}_{∈N(x}_{ᵢ}₎w(xᵢ,xⱼ))P(xᵢ)+Σₓ_{ⱼ}_{∈N(x}_{ᵢ}₎w(xᵢ,xⱼ)P(xⱼ) (14).

P(xᵢ) represents the pixel value of the second pixel of the to-be-diffused map, w(xᵢ,xⱼ) is the sub diffusion intensity corresponding to the third pixel in the to-be-diffused pixel set, N(xᵢ) represents the to-be-diffused pixel set, and P(xⱼ) represents the pixel value of the third pixel in the to-be-diffused pixel set.

After the pixel value of the second pixel of the to-be-diffused map, the sub diffusion intensity corresponding to each pixel in the to-be-diffused pixel set and the pixel value of each pixel in the to-be-diffused pixel set are obtained, specific numerical values of these parameters may be substituted into the formula (14) to calculate the diffused pixel value of the second pixel of the to-be-diffused map.

Exemplarily, an embodiment of the disclosure provides a process of deriving the formula (14).

In an embodiment of the disclosure, the first diffused pixel part may be subtracted from the pixel value of the second pixel of the to-be-diffused map, then the obtained difference and the second diffused part are added, and a final addition result is determined as the diffused pixel value, represented by the formula (15):

P(xᵢ)←P(xᵢ)−p₁(xᵢ)+p₂(xᵢ) (15).

p₁(xᵢ) represents the calculated first diffused part of the second pixel of the to-be-diffused map, p₂(xᵢ) represents the calculated second diffused part of the second pixel of the to-be-diffused map, and P(xᵢ) represents the pixel value of the second pixel of the to-be-diffused map.

The formula (12) and the formula (13) may be substituted into the formula (15) to obtain the formula (16):

P(xᵢ)←P(xᵢ)−Σₓ_{ⱼ}_{∈N(x}_{ᵢ}₎w(xᵢ,xⱼ)P(xᵢ)+Σₓ_{ⱼ}_{∈N(x}_{ᵢ}₎w(xᵢ,xⱼ)P(xⱼ) (16).

Merging and reorganization may be performed on the formula (16) to obtain the formula (14).

Exemplarily, calculation of the diffused pixel value of the second pixel of the to-be-diffused map is illustrated in an embodiment of the disclosure. As shown in FIG. 11, when the diffused pixel value of the second pixel of the to-be-diffused map is calculated based on the to-be-diffused map 1 and the feature map 2, the to-be-diffused pixel set may be determined for the second pixel of the to-be-diffused map at first. In an embodiment of the disclosure, the to-be-diffused pixel set 3 may be determined based on eight neighborhoods. As shown in FIG. 11, the second pixel xᵢ of the to-be-diffused map is in the center of the nine-block box at the left upper part, and a set formed by the eight pixels around is the to-be-diffused pixel set 3. Then, the first feature pixel corresponding to the second pixel of the to-be-diffused map and the second feature pixel corresponding to the third pixel in the to-be-diffused pixel set may be found from the feature map 2, feature extraction may be performed on the first feature pixel by the preset feature extraction model f, and feature extraction may be performed on the second feature pixel by the preset feature extraction model g (a feature extraction process is not shown), both f and g being set to be 1×1 convolution kernels. Next, the diffusion intensity may be calculated by the preset diffusion intensity calculation model 4, i.e., the formula (9). A parameter required for calculation of the diffusion intensity, the pixel value of the second pixel of the to-be-diffused map, and the diffusion intensity and the pixel value of each pixel in the to-be-diffused pixel set may be substituted into the formula (14) to calculate the diffused pixel value 5 of the second pixel of the to-be-diffused map to further obtain the completed depth image 6. In such a manner, calculation of the diffused pixel value of the second pixel of the to-be-diffused map is completed.

In S1033d, the foregoing operations are repeated until the diffused pixel values of all pixels in the to-be-diffused map are calculated.

After pixel diffusion of the second pixel of the to-be-diffused map is completed, the foregoing operations may be continued to be repeated to calculate the diffused pixel value of each pixel in the to-be-diffused map, thereby obtaining a completed depth image.

In an embodiment of the disclosure, the diffused pixel values of all pixels in the to-be-diffused map may be calculated one by one based on the pixel value of each pixel in the to-be-diffused map, the pixel values of all the pixels in the to-be-diffused pixel set corresponding to pixels of the to-be-diffused map and calculated diffusion intensities to obtain a completed depth image with higher accuracy by full use of the collected depth image.

In some embodiments of the disclosure, after the operation that pixel diffusion is implemented based on the to-be-diffused map and the feature map to obtain the completed depth image, namely after S104, the method may further include the following S105.

In S105, the completed depth image is determined as a to-be-diffused map, and the operation that the diffusion intensity of each pixel in the to-be-diffused map is determined based on the to-be-diffused map and the feature map, the operation that the diffused pixel value of each pixel in the to-be-diffused map is determined based on the pixel value of each pixel in the to-be-diffused map and the diffusion intensity of each pixel in the to-be-diffused map and the operation that the completed depth image is determined based on the diffused pixel value of each pixel in the to-be-diffused map are repeatedly executed until a preset repetition times is reached.

After the completed depth image is obtained, the completed depth image may further be continued to be determined as a new to-be-diffused map to calculate a diffused pixel value of each pixel in the to-be-diffused map to implement more complete pixel diffusion to obtain an optimized completed depth image.

In some embodiments of the disclosure, the preset repetition times may be set to be eight. After the completed depth image is obtained, the abovementioned operations may be continued to be executed for seven times for a completed depth image to implement more complete pixel diffusion. It is to be noted that the preset repetition times may be set according to a practical requirement. No limits are made in the embodiments of the disclosure.

In some embodiments of the disclosure, after the operation that the completed depth image is determined based on the diffused pixel value of each pixel in the to-be-diffused map, namely after S104, the method may further include the following S106.

In S106, the completed depth image is determined as a preliminarily completed depth image, and the operation that the first plane origin distance map is calculated based on the preliminarily completed depth image, the parameter matrix of the video camera and the normal prediction map and the first plane origin distance map is determined as the to-be-diffused map, the operation that the diffusion intensity of each pixel in the to-be-diffused map is determined based on the to-be-diffused map and the feature map, the operation that the diffused pixel value of each pixel in the to-be-diffused map is determined based on the pixel value of each pixel in the to-be-diffused map and the diffusion intensity of each pixel in the to-be-diffused map and the operation that the completed depth image is determined based on the diffused pixel value of each pixel in the to-be-diffused map are repeatedly executed until a preset repetition times is reached.

In some embodiments of the disclosure, the operation, executed every time, that the first plane origin distance is calculated based on the preliminarily completed depth image, the parameter matrix of the video camera and the normal prediction map and the first plane origin distance map is determined as the to-be-diffused map includes:

the operation that the first plane origin distance map is calculated based on the preliminarily completed depth image, the parameter matrix of the video camera and the normal prediction map; the operation that the first confidence map is determined based on the depth image and the 2D image; the operation that the second plane origin distance map is calculated based on the depth image, the parameter matrix and the normal prediction map; and the operation that the pixel in the first plane origin distance map is optimized based on the pixel in the first confidence map, the pixel in the second plane origin distance map and the pixel in the first plane origin distance map to obtain the optimized first plane origin distance map and the optimized first plane origin distance map is determined as the to-be-diffused map.

In an embodiment of the disclosure, after the preliminarily completed depth image D, the normal prediction map N and the first confidence map M are obtained based on the collected depth image D̅ and 2D image, second plane origin distance information may be calculated for all the pixels x in the preliminarily completed depth image D to further obtain the second plane origin distance map, and first plane origin distance information of all the pixels may be calculated to further obtain the first plane origin distance map. Then, responsive to determining that a present repetition times is less than a preset iteration count, for each pixel value P(x) in the first plane origin distance map, replacing distance information may be calculated and the pixel value may be optimized to further obtain the optimized first plane origin distance map. Next, the optimized first plane origin distance map may be determined as the to-be-diffused map, and for the second pixel in the optimized first plane origin distance map, the corresponding to-be-diffused pixel set may be determined, the diffusion intensity of the second pixel may be calculated, and the diffused pixel value of the second pixel of the optimized first plane origin distance map may be calculated based on each sub diffusion intensity of the diffusion intensity, the pixel value of each pixel in the to-be-diffused pixel set and the pixel value of the second pixel in the optimized first plane origin distance map to obtain the diffused optimized first plane origin distance map. Inverse transformation may be performed on the diffused optimized first plane origin distance map to obtain the completed depth image. After the completed depth image is obtained, the present repetition times i may be increased by 1 to obtain a new present repetition times, and then the new present repetition times may be compared with the preset repetition times. When the new present repetition times is less than the preset repetition times, the process is continued to be executed. When the new present repetition times is not less than the preset repetition times, a final completed depth image is obtained.

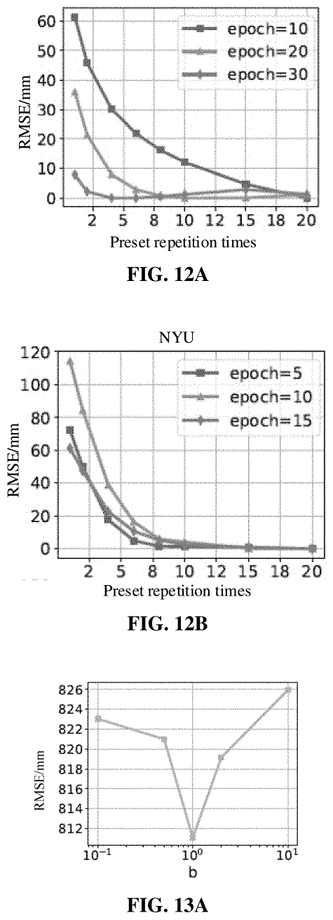

Exemplarily, the impact of a value of the preset repetition times on an error of the completed depth image is presented in an embodiment of the disclosure. As shown in FIG. 12A, a KITTI dataset is adopted for testing, the abscissa is the preset repetition times, and the ordinate is a Root Mean Square Error (RMSE), a unit of the RMSE being mm. The three curves in the figure are results obtained when different values are adopted for an all-sample test number (epoch) respectively. It can be seen from FIG. 12A that: when epoch=10, namely all samples in the KITTI dataset are tested for 10 times, the RMSE decreases along with increase of the preset repetition times. When the preset repetition times is 20, the RMSE is minimum, close to 0; when epoch=20, the RMSE decreases at first along with the preset count repeat and then is kept unchanged, and the RMSE is close to 0; and when epoch=30, the RMSE decreases along with increase of the preset repetition times and then increases to a low extent with a maximum of the RMSE not more than 5 until the RMSE is finally close to 0. FIG. 12B is a diagram of testing results obtained by an NYU dataset. Like FIG. 12A, the abscissa is the preset repetition times and the ordinate is the RMSE in FIG. 12B. The three curves in the figure are results obtained when different values are adopted for the epoch respectively. It can be seen from FIG. 12B that, when epoch=5, epoch=10 or epoch=15, the RMSE decreases along with increase of the preset count repeat until getting close to 0 and then is kept unchanged. It can be seen from FIG. 12A and FIG. 12B that performing pixel diffusion for the preset repetition times may remarkably reduce the RMSE of the completed depth image, namely performing pixel extension for the preset repetition times may further improve the accuracy of the completed depth image.

In an embodiment of the disclosure, after the completed depth image is obtained, completion may be repeatedly performed on the completed depth image, thereby further improving the accuracy of the completed depth image.

In some embodiments of the disclosure, the method for depth image completion may be implemented by a preset prediction model. After a depth image and a 2D image of a target scenario are collected, the preset prediction model pre-stored in a device for depth image completion may be acquired, then the depth image and an image map may be input to the preset prediction model to perform calculation for preliminary prediction processing, and a to-be-diffused map and a feature map may be obtained according to a result output by the preset prediction model to subsequently implement pixel diffusion based on the to-be-diffused map and the feature map.

It can be understood that, in an embodiment of the disclosure, the preset prediction model is a trained model. In an embodiment of the disclosure, a trained CNN model may be adopted as the preset prediction model. Of course, another network model capable of achieving the same purpose or another machine learning model may also be adopted as the preset prediction model according to a practical condition. No limits are made in the embodiments of the disclosure.

Exemplarily, in an embodiment of the disclosure, a variant Residual Network (ResNet)-34 or ResNet-50 of a ResNet in the CNN may be adopted as the preset prediction model.

It is to be noted that, since multiple prediction results such as a preliminarily completed depth image, a normal prediction map and even a confidence map corresponding to the depth image may be obtained based on a practical setting after prediction processing is performed on the collected depth image and 2D image by the preset prediction model, a prediction result obtained by the preset prediction model may be directly determined as the to-be-diffused map, and the prediction result may also be processed to obtain the to-be-diffused map.

It is to be noted that the obtained to-be-diffused map refers to a map obtained according to the output of the preset prediction model and configured for pixel value diffusion. The obtained feature map refers to a feature map obtained by visualizing feature data of a certain layer in the preset prediction model after the depth image and the 2D image are input to the preset prediction model for calculation.

It is to be noted that, since the depth image and the 2D image may be predicted by the preset prediction model to obtain the preliminarily completed depth image and the normal prediction map, namely the preset prediction model has two outputs, the feature map may be obtained by only visualizing feature data in a subnetwork configured to output the preliminarily completed depth image, or the feature map may also be obtained by only visualizing feature data in a subnetwork configured to output the normal prediction map, or the feature map may also be obtained by cascading the subnetwork configured to output the preliminarily completed depth image and the subnetwork configured to output the normal prediction map and visualizing feature data in a cascaded network. Of course, the feature map may also be obtained in another manner No limits are made in the embodiments of the disclosure.

Exemplarily, when the preset prediction model is the ResNet-34, the depth image and the 2D image may be input to the ResNet-34 for prediction, then feature data in the last second layer of the ResNet-34 may be visualized, and a visualization result may be determined as the feature map. Of course, the feature map may also be obtained in another manner No limits are made in the embodiments of the disclosure.

In some embodiments of the disclosure, the preset prediction model may be obtained by the following training method.

In S107, a training sample and a prediction model are acquired.

Before the depth image of the target scenario is collected through the radar and the 2D image of the target scenario is collected through the video camera, it is also necessary to acquire the training sample and the prediction model to subsequently train the prediction model by use of the training sample.

It is to be noted that, since the preliminarily completed depth image, the normal prediction map, the feature map and the first confidence map may be obtained through the preset prediction model, the acquired training sample at least includes a training depth image sample, a training 2D image sample, and a truth value map of the preliminarily completed depth image corresponding to both the training depth image sample and the training 2D image sample, a truth value map of the normal prediction map and a truth value map of the first confidence map. The truth value map of the preliminarily completed depth image refers to an image formed by true depth information of the 3D scenario as pixel values. The truth value map of the normal prediction map refers to an image calculated by performing Principal Component Analysis (PCA) on the truth value map of the preliminarily completed depth image. The truth value map of the first confidence map refers to an image calculated by a training depth image and a truth value map of the depth image.

In an embodiment of the disclosure, a truth value of the confidence of each 3D point is calculated, and the truth value map of the first confidence map is obtained by determining the truth value of the confidence of each 3D point as a pixel value. When the truth value of the confidence of each 3D point is calculated, a truth value of depth information of a 3D point is subtracted from the depth information of the 3D point, an absolute value of an obtained difference is calculated to obtain an absolute value result, then a ratio of the absolute value result to a preset error tolerance parameter is calculated, and finally, a calculation is executed by taking the obtained ratio as an exponent of an exponential function and taking the natural logarithm e as a base number of the exponential function to obtain the truth value of the confidence of each 3D point.

Exemplarily, in an embodiment of the disclosure, a truth value of a confidence of a 3D point may be calculated by use of the formula (17). The formula (17) is as follows:

$${M}^{*} ( x ) = exp ( - \frac{\vert \overline{D} ( x ) - {D}^{*} ( x ) \vert}{b} ) . \qquad ( 17 )$$

D̅(x) represents depth information of a 3D point, D*(x) represents a truth value of training depth information of the 3D point, b is a preset error tolerance parameter, and M*(x) is a calculated truth value of a confidence.

After the depth information of each 3D point, the truth value of the training depth information of each 3D point and a numerical value of the preset error tolerance parameter are acquired, the obtained data may be substituted into the formula (17) to calculate the truth values of the confidences of all 3D points one by one, and the truth value map of the first confidence map may further be obtained by determining the truth value of the confidence of each 3D point as a pixel value.

It is to be noted that, in an embodiment of the disclosure, the preset error tolerance parameter may bring impacts to a calculation process of the truth value map of the first confidence map, so that the preset error tolerance parameter may be set according to experiences. No limits are made in the embodiments of the disclosure.

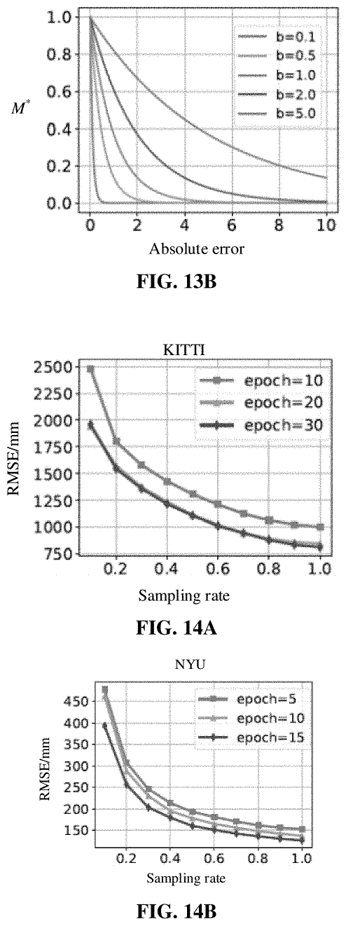

Exemplarily, the impact of the preset error tolerance parameter on the error of the truth value map of the first confidence map is presented in an embodiment of the disclosure. As shown in FIG. 13A, the abscissa is a value of the preset error tolerance parameter b, and the ordinate is RMSEs of truth value maps, calculated by use of different preset error tolerance parameters b, of the first confidence map, a unit of the RMSE being mm. It can be seen from FIG. 13A that, when the value of b gradually increases from 10⁻¹ to 10¹, the RMSE of the truth value map of the first confidence map decreases at first and then increases, and when b is 10⁰, the RMSE of the truth value map of the first confidence map is minimum. It thus can be seen that, for minimizing the RMSE of the truth value map of the first confidence map, the preset error tolerance parameter b may be set to be 10°. An impact of the value of the preset error tolerance parameter on a truth value-AE curve distribution of a confidence is also presented in an embodiment of the disclosure. In FIG. 13B, the abscissa is an AE, a unit of the AE being m, and the ordinate is the confidence truth value M*. From left to right, the five curves in FIG. 13B are sequentially an M*-AE curve distribution in case of b=0.1, an M*-AE curve distribution in case of b=0.5, an M*-AE curve distribution in case of b=1.0, an M*-AE curve distribution in case of b=1.5, an M*-AE curve distribution in case of b=2.0 and an M*-AE curve distribution in case of b=5.0. It can be seen from these curve distributions that, when the value of b is excessively small, for example, when b=0.1 and b=0.5, even though the AE is small, M* of the confidence is also relatively small, and a higher confidence cannot be provided for a confidence truth value with a relatively small error in practical application, namely the confidence is inaccurate; similarly, when the value of b is excessively great, namely when b=2.0 and b=5.0, although the AE is relatively great, the truth value M* of the confidence is relatively great, a tolerance to the noise is higher in practical application, and a relatively low confidence cannot be provided for a confidence truth value with a relatively large error; and when b is 1, M* of the confidence is relatively great for a small AE, M* of the confidence is relatively small for a large AE, and an appropriate confidence may be provided for the confidence truth value.

In S108, the prediction model is predicted by use of the training sample to obtain a prediction parameter.

After the training sample is obtained, supervised training may be performed on the prediction model by use of the training sample. Training is stopped when a loss function reaches a requirement, and the prediction parameter is obtained to subsequently obtain the preset prediction model.

It is to be noted that, when the prediction model is trained, supervised training is performed by taking the training depth image sample and the training 2D image sample as inputs and taking the truth value map of the preliminarily completed depth image corresponding to both the training depth image sample and the training 2D image sample, the truth value map of the normal prediction map and the truth value map of the first confidence map for supervision.

In an embodiment of the disclosure, sub loss functions may be set for the truth value map of the preliminarily completed depth image, the truth value map of the normal prediction map and the truth value map of the first confidence map respectively. These sub loss functions are multiplied by a weight regulation parameter of a corresponding loss function respectively, and finally, the loss function of the preset prediction model is obtained based on multiplication results.

Exemplarily, the loss function of the preset prediction model may be set to be:

L=L_{D}+βL_{N}+γL_{C} (18).

L_{D} is a sub loss function corresponding to the truth value map of the preliminarily completed depth image, L_{N} is a sub loss function corresponding to the truth value map of the normal prediction map, L_{C} is a sub loss function corresponding to the truth value map of the first confidence map, and β and γ are weight regulation parameters of the loss function. Of course, the loss function of the preset prediction model may also be set in another form. No limits are made in the embodiments of the disclosure.

It is to be noted that the weight regulation parameter of the loss function may be set according to a practical requirement. No limits are made in the embodiments of the disclosure.

The sub loss function corresponding to the truth value map of the preliminarily completed depth image may be set to be:

$${L}_{D} = \frac{1}{n} {\sum }_{x} {‖ D ( x ) - {D}^{*} ( x ) ‖}_{2}^{2} . \qquad ( 19 )$$

D(x) represents predicted preliminary depth information of a 3D point in the training sample, D*(x) represents a truth value of original depth information of the 3D point, and n is the total number of the pixels in the preliminarily completed depth image.

The sub loss function corresponding to the truth value map of the normal prediction map may be set to be:

$${L}_{N} = - \frac{1}{n} {\sum }_{x} N ( x ) \cdot {N}^{*} ( x ) . \qquad ( 20 )$$

N(x) represents a predicted normal vector of the tangent plane where a 3D point is located in the training sample, N(x) is a true normal vector of the 3D point, and n is the total number of the pixels in the normal prediction map.

The sub loss function corresponding to the truth value map of the first confidence map may be set to be:

$${L}_{C} = \frac{1}{n} {\sum }_{x} {‖ M ( x ) - {M}^{*} ( x ) ‖}_{2}^{2} . \qquad ( 21 )$$

M(x) represents predicted confidence information corresponding to a 3D point in the training sample, M*(x) represents the truth value, calculated through the formula (17), of the confidence information corresponding to the 3D point, and n is the total number of the pixels in the first confidence map.

It is to be noted that many hyperparameters may impose an impact on the performance such as a sampling rate of the finally obtained preset prediction model in a training process. Therefore, an appropriate hyperparameter may be selected to train the prediction model to subsequently obtain a preset prediction model with a better effect.

In S109, the preset prediction model is formed by the prediction parameter and the prediction model.

After the prediction model is trained to obtain the prediction parameter, the preset prediction model may be formed by the obtained prediction parameter and the prediction model such that a device may subsequently predict the depth image and 2D image collected by the device by use of the preset prediction model.

Exemplarily, an impact of the sampling rate of the preset prediction model on the completed depth image is illustrated in an embodiment of the disclosure. As shown in FIG. 14A, the KITTI dataset is adopted for testing, the abscissa is the sampling rate, and the ordinate is the RMSE, the unit of the RMSE being mm. The three curves in the figure are results obtained when epoch=10, epoch=2- and epoch=30 respectively. It can be seen from FIG. 14A that, when epoch=10, epoch=20 or epoch=30, the RMSE decreases when the sampling rate progressively increases from 0 to 1.0, and the RMSE is minimum when the sampling rate is 1.0. FIG. 14B shows testing results obtained by the NYU dataset. Like FIG. 14A, in FIG. 14B, the abscissa is the sampling rate, and the ordinate is the RMSE, the unit of the RMSES being mm. The three curves in the figure are results obtained when epoch=10, epoch=20 and epoch=30 respectively. Like FIG. 14A, in FIG. 14B, when epoch=10, epoch=20 or epoch=30, the RMSE may decrease when the sampling rate progressively increases from 0 to 1.0, and is minimum when the sampling rate is 1.0. It can be seen from FIG. 14A and FIG. 14B that selecting an appropriate sampling rate for the preset prediction model may remarkably reduce the RMSE of the completed depth image, namely obtaining a completed depth image with a better effect.

In an embodiment of the disclosure, the prediction model may be trained to obtain the prediction parameter, and the preset prediction model may be formed by the prediction parameter and the prediction model, so that prediction processing may be subsequently performed on a depth image and a 2D image collected in real time by use of the preset prediction model.

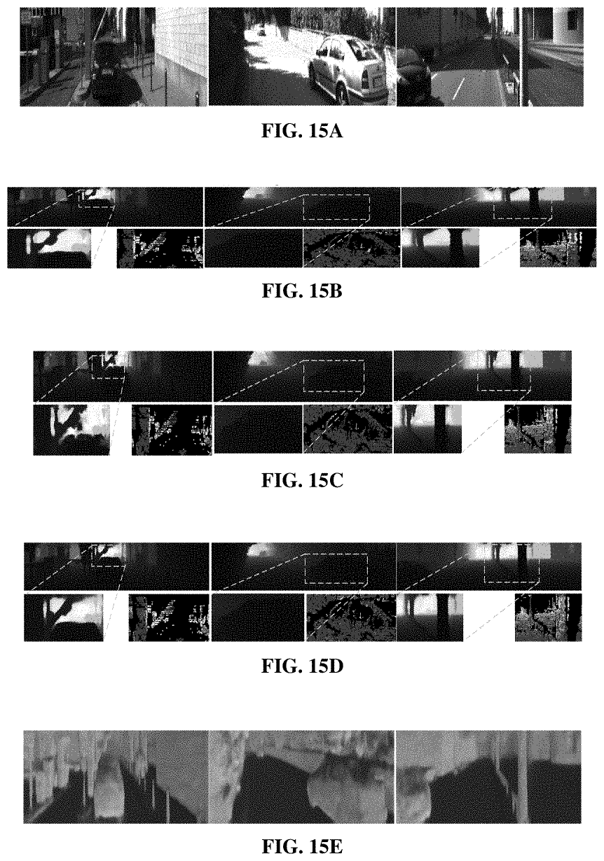

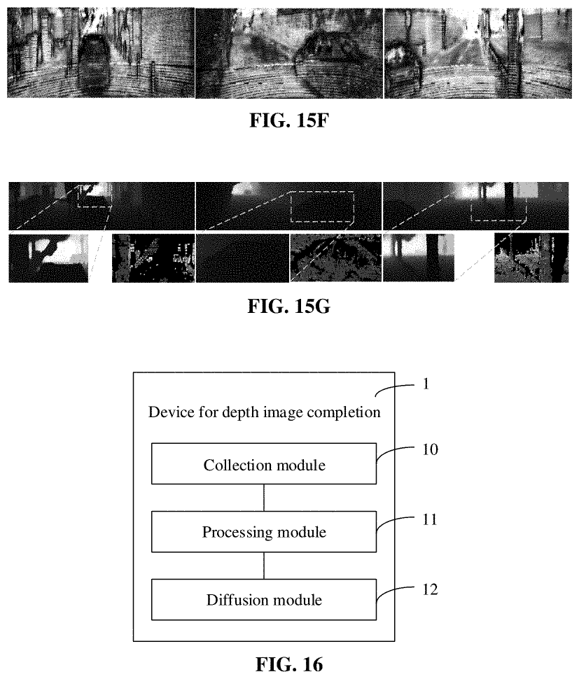

Exemplarily, an embodiment of the disclosure provides a comparison diagram of effects of the method for depth image completion and a depth completion technology in related art. FIG. 15A is a schematic diagram of a collected depth image and 2D image of a 3D scenario. For convenient observation, the depth image and the 2D image are overlapped for presentation. FIG. 15B is a completed depth image obtained by performing depth completion by use of a CSPN in related art. FIG. 15C is a completed depth image obtained by an NConv-CNN in related art. FIG. 15D is a completed depth image obtained by a sparse-to-dense method in related art. FIG. 15E is a predicted normal prediction map according to an embodiment of the disclosure. FIG. 15F is a predicted first confidence map according to an embodiment of the disclosure. FIG. 15G is a completed depth image obtained by the method for depth image completion provided in an embodiment of the disclosure. Comparison between FIG. 15B, FIG. 15C, FIG. 15D and FIG. 15G shows that, compared with the related art, the method for depth image completion provided in the embodiment of the disclosure has the advantages that the effect of the completed depth image is better, the number of pixels with error depth information is smaller, and detailed information of the completed depth image is more comprehensive.

It can be understood by those skilled in the art that, in the method of the specific implementation modes, the sequence of each operation does not mean a strict execution sequence and is not intended to form any limit to the implementation process and a specific execution sequence of each operation should be determined by functions and probable internal logic thereof.

In some embodiments of the disclosure, as shown in FIG. 16, the embodiments of the disclosure provide a device 1 for depth image completion. The device 1 for depth image completion may include a collection module 10, a processing module 11 and a diffusion module 12.

The collection module 10 is configured to collect a depth image of a target scenario through an arranged radar and collect a 2D image of the target scenario through an arranged video camera.

The processing module 11 is configured to determine a to-be-diffused map and a feature map based on the collected depth image and the collected 2D image and determine a diffusion intensity of each pixel in the to-be-diffused map based on the to-be-diffused map and the feature map, the diffusion intensity representing an intensity of diffusion of a pixel value of each pixel in the to-be-diffused map to an adjacent pixel.

The diffusion module 12 is configured to determine a completed depth image based on the pixel value of each pixel in the to-be-diffused map and the diffusion intensity of each pixel in the to-be-diffused map.

In some embodiments of the disclosure, the diffusion module 12 is further configured to determine a diffused pixel value of each pixel in the to-be-diffused map based on the pixel value of each pixel in the to-be-diffused map and the diffusion intensity of each pixel in the to-be-diffused map and determine the completed depth image based on the diffused pixel value of each pixel in the to-be-diffused map.

In some embodiments of the disclosure, the to-be-diffused map is a preliminarily completed depth image; and the diffusion module 12, when being configured to determine the completed depth image based on the diffused pixel value of each pixel in the to-be-diffused map, is further configured to determine the diffused pixel value of each pixel in the to-be-diffused map as a pixel value of each pixel of a diffused image and determine the diffused image as the completed depth image.

In some embodiments of the disclosure, the to-be-diffused map is a first plane origin distance map; and the processing module 11, when being configured to determine the to-be-diffused map and the feature map based on the depth image and the 2D image, is further configured to acquire a parameter matrix of the video camera, determine the preliminarily completed depth image, the feature map and a normal prediction map based on the depth image and the 2D image, the normal prediction map referring to an image taking a normal vector of each point in the 3D scenario as a pixel value, and calculate the first plane origin distance map based on the preliminarily completed depth image, the parameter matrix of the video camera and the normal prediction map, the first plane origin distance map being an image calculated based on the preliminarily completed depth image and taking a distance from the video camera to a plane where each point in the 3D scenario is located as a pixel value.

In some embodiments of the disclosure, the processing module 11 is further configured to determine a first confidence map based on the depth image and the 2D image, the first confidence map referring to an image taking a confidence of each pixel in the depth image as a pixel value; calculate a second plane origin distance map based on the depth image, the parameter matrix and the normal prediction map, the second plane origin distance map being an image taking a distance, calculated based on the collected depth image, from the video camera to a plane where each point in the 3D scenario is located as a pixel value; and optimize a pixel in the first plane origin distance map based on a pixel in the first confidence map, a pixel in the second plane origin distance map and the pixel in the first plane origin distance map to obtain an optimized first plane origin distance map.

In some embodiments of the disclosure, the processing module 11, when being configured to optimize the pixel in the first plane origin distance map based on the pixel in the first confidence map, the pixel in the second plane origin distance map and the pixel in the first plane origin distance map to obtain the optimized first plane origin distance map, is further configured to determine a pixel corresponding to a first pixel of the first plane origin distance map in the second plane origin distance map as a replacing pixel; determine a pixel value of the replacing pixel, the first pixel being any pixel in the first plane origin distance map; determine confidence information of the replacing pixel in the first confidence map; determine an optimized pixel value of the first pixel of the first plane origin distance map based on the pixel value of the replacing pixel, the confidence information and a pixel value of the first pixel of the first plane origin distance map and repeat the operations until optimized pixel values of all pixels in the first plane origin distance map are determined to obtain the optimized first plane origin distance map.

In some embodiments of the disclosure, the processing module 11, when being configured to determine the diffusion intensity of each pixel in the to-be-diffused map based on the to-be-diffused map and the feature map, is further configured to determine a to-be-diffused pixel set corresponding to a second pixel of the to-be-diffused map in the to-be-diffused map based on a preset diffusion range; determine a pixel value of each pixel in the to-be-diffused pixel set, the second pixel being any pixel in the to-be-diffused map; and calculate a diffusion intensity of the second pixel of the to-be-diffused map based on the feature map, the second pixel of the to-be-diffused map and each pixel in the to-be-diffused pixel set.

The diffusion module 12, when being configured to determine the diffused pixel value of each pixel in the to-be-diffused map based on the pixel value of each pixel in the to-be-diffused map and the diffusion intensity of each pixel in the to-be-diffused map, is further configured to determine a diffused pixel value of the second pixel of the to-be-diffused map based on the diffusion intensity of the second pixel of the to-be-diffused map, a pixel value of the second pixel of the to-be-diffused map and the pixel value of each pixel in the to-be-diffused pixel set and repeat the operation until the diffused pixel values of all pixels in the to-be-diffused map are determined.

In some embodiments of the disclosure, the processing module 11, when being configured to calculate the diffusion intensity of the second pixel of the to-be-diffused map based on the feature map, the second pixel of the to-be-diffused map and each pixel in the to-be-diffused pixel set, is further configured to: calculate an intensity normalization parameter corresponding to the second pixel of the to-be-diffused map based on the second pixel of the to-be-diffused map and each pixel in the to-be-diffused pixel set; in the feature map; determine a pixel corresponding to the second pixel of the to-be-diffused map as a first feature pixel and determine a pixel corresponding to a third pixel in the to-be-diffused pixel set as a second feature pixel, the third pixel being any pixel in the to-be-diffused pixel set; extract feature information of the first feature pixel and feature information of the second feature pixel; calculate a sub diffusion intensity of a diffused pixel pair formed by the second pixel of the to-be-diffused map and the third pixel in the to-be-diffused pixel set based on the feature information of the first feature pixel, the feature information of the second feature pixel, the intensity normalization parameter and a preset diffusion control parameter; repeat the operations until sub diffusion intensities of pixel pairs formed by the second pixel of the to-be-diffused map and each pixel in the to-be-diffused pixel set are determined; and determine the sub diffusion intensity of the diffused pixel pair formed by the second pixel of the to-be-diffused map and each pixel in the to-be-diffused pixel set as the diffusion intensity of the second pixel of the to-be-diffused map.

In some embodiments of the disclosure, the processing module 11, when being configured to calculate the intensity normalization parameter corresponding to the second pixel of the to-be-diffused map based on the second pixel of the to-be-diffused map and each pixel in the to-be-diffused pixel set, is further configured to: extract feature information of the second pixel of the to-be-diffused map and feature information of the third pixel in the to-be-diffused pixel set; calculate a sub normalization parameter of the third pixel in the to-be-diffused pixel set based on the extracted feature information of the second pixel of the to-be-diffused map and feature information of the third pixel in the to-be-diffused pixel set and the preset diffusion control parameter; repeat the operations until sub normalization parameters of all pixels of the to-be-diffused pixel set are obtained and accumulate the sub normalization parameters of all the pixels of the to-be-diffused pixel set to obtain the intensity normalization parameter corresponding to the second pixel of the to-be-diffused map.

In some embodiments of the disclosure, the diffusion module 12, when being configured to determine the diffused pixel value of the second pixel of the to-be-diffused map based on the diffusion intensity of the second pixel of the to-be-diffused map, the pixel value of the second pixel of the to-be-diffused map and the pixel value of each pixel in the to-be-diffused pixel set, is further configured to: multiply each sub diffusion intensity of the diffusion intensity by the pixel value of the second pixel of the to-be-diffused map, accumulate obtained product results to obtain a first diffused part of the second pixel of the to-be-diffused map; multiply each sub diffusion intensity of the diffusion intensity by a pixel value of each pixel in the to-be-diffused pixel set, accumulate obtained products to obtain a second diffused part of the second pixel of the to-be-diffused map; and calculate the diffused pixel value of the second pixel of the to-be-diffused map based on the pixel value of the second pixel of the to-be-diffused map, the first diffused part of the second pixel of the to-be-diffused map and the second diffused part of the second pixel of the to-be-diffused map.

In some embodiments of the disclosure, the diffusion module 12 is further configured to: determine the completed depth image as a to-be-diffused map; and repeatedly execute the operation of determining the diffusion intensity of each pixel in the to-be-diffused map based on the to-be-diffused map and the feature map, the operation of determining the diffused pixel value of each pixel in the to-be-diffused map based on the pixel value of each pixel in the to-be-diffused map and the diffusion intensity of each pixel in the to-be-diffused map and the operation of determining the completed depth image based on the diffused pixel value of each pixel in the to-be-diffused map until a preset repetition times is reached.

In some embodiments of the disclosure, the diffusion module 12 is further configured to determine the completed depth image as a preliminarily completed depth image and repeatedly execute the operation of calculating the first plane origin distance map based on the preliminarily completed depth image, the parameter matrix of the video camera and the normal prediction map and determining the first plane origin distance map as the to-be-diffused map, the operation of determining the diffusion intensity of each pixel in the to-be-diffused map based on the to-be-diffused map and the feature map, the operation of determining the diffused pixel value of each pixel in the to-be-diffused map based on the pixel value of each pixel in the to-be-diffused map and the diffusion intensity of each pixel in the to-be-diffused map and the operation of determining the completed depth image based on the diffused pixel value of each pixel in the to-be-diffused map until the preset repetition times is reached.

In some embodiments of the disclosure, the diffusion module 12, when being configured to execute the of calculating the first plane origin distance map based on the preliminarily completed depth image, the parameter matrix of the video camera and the normal prediction map and determining the first plane origin distance map as the to-be-diffused map every time, is further configured to execute the operation of calculating the first plane origin distance map based on the preliminarily completed depth image, the parameter matrix of the video camera and the normal prediction map, the operation of determining the first confidence map based on the depth image and the 2D image, the operation of calculating the second plane origin distance map based on the depth image, the parameter matrix and the normal prediction map and the operation of optimizing the pixel in the first plane origin distance map based on the pixel in the first confidence map, the pixel in the second plane origin distance map and the pixel in the first plane origin distance map to obtain the optimized first plane origin distance map and determining the optimized first plane origin distance map as the to-be-diffused map.

In some embodiments, functions or modules of the device provided in the embodiments of the disclosure may be configured to execute the method described in the method embodiment and specific implementation thereof may refer to the descriptions about the method embodiment and, for simplicity, will not be elaborated herein.

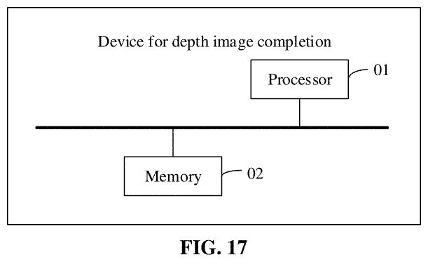

In some embodiments of the disclosure, FIG. 17 is a composition structure diagram of a device for depth image completion according to an embodiment of the disclosure. As shown in FIG. 17, the device for depth image completion disclosed in the disclosure may include a processor 01 and a memory 02 storing an instructions executable for the processor 01. The processor 01 is configured to execute executable depth image completion instructions stored in the memory to implement a method for depth image completion provided in the embodiments of the disclosure.

In an embodiment of the disclosure, the processor 01 may be at least one of following: an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing unit (CPU), a controller, a microcontroller and a microprocessor. It can be understood that, for different devices, other electronic components may be configured to realize functions of the processor, and no limits are made in an embodiment of the disclosure. The terminal further includes the memory 02. The memory 02 may be connected with the processor 01. The memory 02 may include a high-speed Random Access Memory (RAM) and may also include a non-volatile memory, for example, at least two disk memories.

In practical application, the memory 02 may be a volatile memory such as a RAM, or a non-volatile memory such as a Read-Only Memory (ROM), a flash memory, a Hard Disk Drive (HDD) or a Solid-State Drive (SSD), or a combination of the memories, and provides instructions and data for the processor 01.

In addition, each functional module in the embodiment may be integrated into a processing unit, each unit may also exist independently, and two or more than two units may also be integrated into a unit. The integrated unit may be implemented in a hardware form or may also be implemented in form of software function module.

When implemented in form of a software function module and sold or used not as an independent product, the integrated unit may be stored in a computer-readable storage medium. Based on such an understanding, the technical solution of the embodiment substantially or parts making contributions to the conventional art or all or part of the technical solution may be embodied in form of software product. The computer software product is stored in a storage medium, including a plurality of instructions configured to enable a computer device (which may be a personal computer, a server, a network device or the like) or a processor to execute all or part of the operations of the method in the embodiments. The abovementioned storage medium includes: various media capable of storing program codes such as a U disk, a mobile hard disk, a ROM, a RAM, a magnetic disk or an optical disk.

It can be understood that the device for depth image completion in the embodiment of the disclosure may be a device with a computing function, for example, a desktop computer, a notebook computer, a microcomputer and a vehicle-mounted computer. A specific implementation form of the device may be determined based on a practical requirement. No limits are made in the embodiments of the disclosure.

The embodiments of the disclosure provide a computer-readable storage medium, which has stored executable depth image completion instructions and is applied to a terminal. A program is executed by a processor to implement a method for depth image completion provided in the embodiments of the disclosure.

The embodiments of the disclosure provide a method and device for depth image completion and a computer-readable storage medium. A depth image of a target scenario may be collected through an arranged radar, and a 2D image of the target scenario may be collected through an arranged video camera; a to-be-diffused map and a feature map may be determined based on the collected depth image and 2D image; a diffusion intensity of each pixel in the to-be-diffused map may be determined based on the to-be-diffused map and the feature map, the diffusion intensity representing an intensity of diffusion of a pixel value of each pixel in the to-be-diffused map to an adjacent pixel; and a completed depth image may be determined based on the pixel value of each pixel in the to-be-diffused map and the diffusion intensity of each pixel in the to-be-diffused map. In such an implementation, the to-be-diffused map may be obtained based on the collected depth image and 2D image, all point cloud data in the collected depth image may be retained in the to-be-diffused map, and when a diffused pixel value of each pixel in the to-be-diffused map is determined based on the pixel value of each pixel in the to-be-diffused map and the corresponding diffusion intensity, all the point cloud data in the collected depth image can be utilized, so that the point cloud data in the collected depth image is fully utilized, the accuracy of depth information of each 3D point in a 3D scenario becomes higher, and the accuracy of the completed depth image is improved.

Those skilled in the art should know that the embodiment of the disclosure may be provided as a method, a system or a computer program product. Therefore, the disclosure may adopt a form of hardware embodiment, software embodiment or combined software and hardware embodiment. Moreover, the disclosure may adopt a form of computer program product implemented on one or more computer-available storage media (including, but not limited to, a disk memory and an optical memory) including computer-available program codes.

The disclosure is described with reference to implementation flowcharts and/or block diagrams of the method, device (system) and computer program product according to the embodiments of the disclosure. It is to be understood that each flow and/or block in the flowcharts and/or the block diagrams and combinations of the flows and/or blocks in the implementation flowcharts and/or the block diagrams may be implemented by computer program instructions. These computer program instructions may be provided for a universal computer, a dedicated computer, an embedded processor or a processor of another programmable data processing device to generate a machine, so that a device for realizing a function specified in one flow or multiple flows in the implementation flowcharts and/or one block or multiple blocks in the block diagrams is generated by the instructions executed through the computer or the processor of the other programmable data processing device.

These computer program instructions may also be stored in a computer-readable memory capable of guiding the computer or other programmable data processing device to work in a specific manner, so that a product including instructions may be generated by the instructions stored in the computer-readable memory, the instructions device realizing the function specified in one flow or multiple flows in the implementation flowcharts and/or one block or multiple blocks in the block diagrams.

These computer program instructions may further be loaded onto the computer or the other programmable data processing device, so that a series of operations are executed on the computer or the other programmable data processing device to generate processing implemented by the computer, and operations for realizing the function specified in one flow or multiple flows in the implementation flowcharts and/or one block or multiple blocks in the block diagrams are provided by the instructions executed on the computer or the other programmable data processing device.

In subsequent descriptions, suffixes configured to represent components, like “module”, “part” or “unit”, are adopted only for convenient description about the disclosure, and they do not have any specific meaning. Therefore, “module”, “part” or “unit” may be mixed for use.

The above is only the preferred embodiment of the disclosure and not intended to limit the scope of protection of the disclosure.

### INDUSTRIAL APPLICABILITY

In the embodiments, the device for depth image completion may obtain a to-be-diffused map based on a collected depth image and 2D image, all point cloud data in the collected depth image may be retained in the to-be-diffused map, and when a diffused pixel value of each pixel in the to-be-diffused map is determined based on a pixel value of each pixel in the to-be-diffused map and the corresponding diffusion intensity, all the point cloud data in the collected depth image may be utilized, so that the point cloud data in the collected depth image is fully utilized, the accuracy of depth information of each 3D point in a 3D scenario becomes higher, and the accuracy of the completed depth image is improved.

1. A method for depth image completion, comprising:
collecting a depth image of a target scenario through an arranged radar, and collecting a two-dimensional (2D) image of the target scenario through an arranged video camera;
determining a to-be-diffused map and a feature map based on the collected depth image and 2D image;
determining a diffusion intensity of each pixel in the to-be-diffused map based on the to-be-diffused map and the feature map, the diffusion intensity representing an intensity of diffusion of a pixel value of each pixel in the to-be-diffused map to an adjacent pixel; and
determining a completed depth image based on the pixel value of each pixel in the to-be-diffused map and the diffusion intensity of each pixel in the to-be-diffused map.

2. The method of claim 1, wherein determining the completed depth image based on the pixel value of each pixel in the to-be-diffused map and the diffusion intensity of each pixel in the to-be-diffused map comprises:
determining a diffused pixel value of each pixel in the to-be-diffused map based on the pixel value of each pixel in the to-be-diffused map and the diffusion intensity of each pixel in the to-be-diffused map; and
determining the completed depth image based on the diffused pixel value of each pixel in the to-be-diffused map.

3. The method of claim 2, wherein the to-be-diffused map is a preliminarily completed depth image; and determining the completed depth image based on the diffused pixel value of each pixel in the to-be-diffused map comprises:
determining the diffused pixel value of each pixel in the to-be-diffused map as a pixel value of each pixel of a diffused image, and
determining the diffused image as the completed depth image.

4. The method of claim 2, wherein the to-be-diffused map is a first plane origin distance map; and determining the to-be-diffused map and the feature map based on the depth image and the 2D image comprises:
acquiring a parameter matrix of the video camera,
determining the preliminarily completed depth image, the feature map and a normal prediction map based on the collected depth image and 2D image, the normal prediction map referring to an image taking a normal vector of each point in a three-dimensional (3D) scenario as a pixel value, and
calculating the first plane origin distance map based on the preliminarily completed depth image, the parameter matrix of the video camera and the normal prediction map, the first plane origin distance map being an image taking a distance, calculated based on the preliminarily completed depth image, from the video camera to a plane where each point in the 3D scenario is located as a pixel value.

5. The method of claim 4, further comprising:
determining a first confidence map based on the collected depth image and the collected 2D image, the first confidence map referring to an image taking a confidence of each pixel in the collected depth image as a pixel value;
calculating a second plane origin distance map based on the collected depth image, the parameter matrix and the normal prediction map, the second plane origin distance map being an image taking a distance, calculated based on the collected depth image, from the video camera to the plane where each point in the 3D scenario is located as a pixel value; and
optimizing a pixel in the first plane origin distance map based on a pixel in the first confidence map, a pixel in the second plane origin distance map and the pixel in the first plane origin distance map to obtain an optimized first plane origin distance map.

6. The method of claim 5, wherein optimizing the pixel in the first plane origin distance map based on the pixel in the first confidence map, the pixel in the second plane origin distance map and the pixel in the first plane origin distance map to obtain the optimized first plane origin distance map comprises:
determining a pixel corresponding to a first pixel of the first plane origin distance map in the second plane origin distance map as a replacing pixel, and determining a pixel value of the replacing pixel, the first pixel being any pixel in the first plane origin distance map;
determining confidence information of the replacing pixel in the first confidence map;
determining an optimized pixel value of the first pixel of the first plane origin distance map based on the pixel value of the replacing pixel, the confidence information and a pixel value of the first pixel of the first plane origin distance map; and
repeating the operations until optimized pixel values of all pixels of the first plane origin distance map are determined to obtain the optimized first plane origin distance map.

7. The method of claim 2, wherein
determining the diffusion intensity of each pixel in the to-be-diffused map based on the to-be-diffused map and the feature map comprises:
determining a to-be-diffused pixel set corresponding to a second pixel of the to-be-diffused map in the to-be-diffused map based on a preset diffusion range, and determining a pixel value of each pixel in the to-be-diffused pixel set, the second pixel being any pixel in the to-be-diffused map, and
calculating a diffusion intensity of the second pixel of the to-be-diffused map based on the feature map, the second pixel of the to-be-diffused map and each pixel in the to-be-diffused pixel set; and
determining the diffused pixel value of each pixel in the to-be-diffused map based on the pixel value of each pixel in the to-be-diffused map and the diffusion intensity of each pixel in the to-be-diffused map comprises:
determining a diffused pixel value of the second pixel of the to-be-diffused map based on the diffusion intensity of the second pixel of the to-be-diffused map, a pixel value of the second pixel of the to-be-diffused map and the pixel value of each pixel in the to-be-diffused pixel set, and
repeating the operation until the diffused pixel values of all pixels in the to-be-diffused map are determined.

8. The method of claim 7, wherein calculating the diffusion intensity of the second pixel of the to-be-diffused map based on the feature map, the second pixel of the to-be-diffused map and each pixel in the to-be-diffused pixel set comprises:
calculating an intensity normalization parameter corresponding to the second pixel of the to-be-diffused map based on the second pixel of the to-be-diffused map and each pixel in the to-be-diffused pixel set;
determining a pixel corresponding to the second pixel in the to-be-diffused map in the feature map as a first feature pixel;
determining a pixel corresponding to a third pixel in the to-be-diffused pixel set in the feature map as a second feature pixel, the third pixel being any pixel in the to-be-diffused pixel set;
extracting feature information of the first feature pixel and feature information of the second feature pixel;
calculating a sub diffusion intensity of a diffused pixel pair formed by the second pixel of the to-be-diffused map and the third pixel in the to-be-diffused pixel set based on the feature information of the first feature pixel, the feature information of the second feature pixel, the intensity normalization parameter and a preset diffusion control parameter;
repeating the operations until sub diffusion intensities of pixel pairs formed by the second pixel of the to-be-diffused map and each pixel in the to-be-diffused pixel set are determined; and
determining the sub diffusion intensity of the diffused pixel pair formed by the second pixel of the to-be-diffused map and each pixel in the to-be-diffused pixel set as the diffusion intensity of the second pixel of the to-be-diffused map.

9. The method of claim 8, wherein the sub diffusion intensity is a similarity between the second pixel in the to-be-diffused map and the third pixel in the to-be-diffused pixel set.

10. The method of claim 8, wherein calculating the intensity normalization parameter corresponding to the second pixel of the to-be-diffused map based on the second pixel of the to-be-diffused map and each pixel in the to-be-diffused pixel set comprises:
extracting feature information of the second pixel of the to-be-diffused map and feature information of the third pixel in the to-be-diffused pixel set;
calculating a sub normalization parameter of the third pixel in the to-be-diffused pixel set based on the extracted feature information of the second pixel of the to-be-diffused map and the extracted feature information of the third pixel in the to-be-diffused pixel set and the preset diffusion control parameter;
repeating the operations until sub normalization parameters of all the pixels of the to-be-diffused pixel set are obtained; and
accumulating the sub normalization parameters of all the pixels of the to-be-diffused pixel set to obtain the intensity normalization parameter corresponding to the second pixel of the to-be-diffused map.

11. The method of claim 8, wherein determining the diffused pixel value of the second pixel of the to-be-diffused map based on the diffusion intensity of the second pixel of the to-be-diffused map, the pixel value of the second pixel of the to-be-diffused map and the pixel value of each pixel in the to-be-diffused pixel set comprises:
multiplying each sub diffusion intensity of the diffusion intensity by the pixel value of the second pixel of the to-be-diffused map, and accumulating obtained product results to obtain a first diffused part of the second pixel of the to-be-diffused map;
multiplying each sub diffusion intensity of the diffusion intensity by the pixel value of each pixel in the to-be-diffused pixel set, and accumulating obtained products to obtain a second diffused part of the second pixel of the to-be-diffused map; and
calculating the diffused pixel value of the second pixel of the to-be-diffused map based on the pixel value of the second pixel of the to-be-diffused map, the first diffused part of the second pixel of the to-be-diffused map and the second diffused part of the second pixel of the to-be-diffused map.

12. The method of claim 3, after determining the completed depth image based on the diffused pixel value of each pixel in the to-be-diffused map, the method further comprising:
determining the completed depth image as a to-be-diffused map, and repeatedly executing the operation of determining the diffusion intensity of each pixel in the to-be-diffused map based on the to-be-diffused map and the feature map, the operation of determining the diffused pixel value of each pixel in the to-be-diffused map based on the pixel value of each pixel in the to-be-diffused map and the diffusion intensity of each pixel in the to-be-diffused map and the operation of determining the completed depth image based on the diffused pixel value of each pixel in the to-be-diffused map until a preset repetition times is reached.

13. The method of claim 4, after determining the completed depth image based on the diffused pixel value of each pixel in the to-be-diffused map, the method further comprising:
determining the completed depth image as a preliminarily completed depth image, and repeatedly executing the operation of calculating the first plane origin distance map based on the preliminarily completed depth image, the parameter matrix of the video camera and the normal prediction map and determining the first plane origin distance map as the to-be-diffused map, the operation of determining the diffusion intensity of each pixel in the to-be-diffused map based on the to-be-diffused map and the feature map, the operation of determining the diffused pixel value of each pixel in the to-be-diffused map based on the pixel value of each pixel in the to-be-diffused map and the diffusion intensity of each pixel in the to-be-diffused map and the operation of determining the completed depth image based on the diffused pixel value of each pixel in the to-be-diffused map until a preset repetition times is reached.

14. The method of claim 13, wherein the operation, executed every time, of calculating the first plane origin distance map based on the preliminarily completed depth image, the parameter matrix of the video camera and the normal prediction map and determining the first plane origin distance map as the to-be-diffused map comprises:
the operation of calculating the first plane origin distance map based on the preliminarily completed depth image, the parameter matrix of the video camera and the normal prediction map;
the operation of determining the first confidence map based on the collected depth image and the collected 2D image;
the operation of calculating the second plane origin distance map based on the collected depth image, the parameter matrix and the normal prediction map; and
the operation of optimizing the pixel in the first plane origin distance map based on the pixel in the first confidence map, the pixel in the second plane origin distance map and the pixel in the first plane origin distance map to obtain the optimized first plane origin distance map and determining the optimized first plane origin distance map as the to-be-diffused map.

15. A device for depth image completion, comprising a memory and a processor, wherein
the memory is configured to store executable depth image completion instructions; and
the processor is configured to execute the executable depth image completion instructions stored in the memory to implement operations comprising:
collecting a depth image of a target scenario through an arranged radar, and collecting a two-dimensional (2D) image of the target scenario through an arranged video camera;
determining a to-be-diffused map and a feature map based on the collected depth image and 2D image;
determining a diffusion intensity of each pixel in the to-be-diffused map based on the to-be-diffused map and the feature map, the diffusion intensity representing an intensity of diffusion of a pixel value of each pixel in the to-be-diffused map to an adjacent pixel; and
determining a completed depth image based on the pixel value of each pixel in the to-be-diffused map and the diffusion intensity of each pixel in the to-be-diffused map.

16. The device of claim 15, wherein the processor is further configured to:
determine a diffused pixel value of each pixel in the to-be-diffused map based on the pixel value of each pixel in the to-be-diffused map and the diffusion intensity of each pixel in the to-be-diffused map; and
determine the completed depth image based on the diffused pixel value of each pixel in the to-be-diffused map.

17. The device of claim 16, wherein the to-be-diffused map is a preliminarily completed depth image; and the processor is further configured to:
determine the diffused pixel value of each pixel in the to-be-diffused map as a pixel value of each pixel of a diffused image, and
determine the diffused image as the completed depth image.

18. The device of claim 16, wherein the to-be-diffused map is a first plane origin distance map; and the processor is further configured to:
acquire a parameter matrix of the video camera,
determine the preliminarily completed depth image, the feature map and a normal prediction map based on the collected depth image and 2D image, the normal prediction map referring to an image taking a normal vector of each point in a three-dimensional (3D) scenario as a pixel value, and
calculate the first plane origin distance map based on the preliminarily completed depth image, the parameter matrix of the video camera and the normal prediction map, the first plane origin distance map being an image taking a distance, calculated based on the preliminarily completed depth image, from the video camera to a plane where each point in the 3D scenario is located as a pixel value.

19. The device of claim 18, wherein the processor is further configured to:
determine a first confidence map based on the depth image and the 2D image, the first confidence map referring to an image taking a confidence of each pixel in the depth image as a pixel value,
calculate a second plane origin distance map based on the depth image, the parameter matrix and the normal prediction map, the second plane origin distance map being an image taking a distance, calculated based on the collected depth image, from the video camera to the plane where each point in the 3D scenario is located as a pixel value, and
optimize a pixel in the first plane origin distance map based on a pixel in the first confidence map, a pixel in the second plane origin distance map and the pixel in the first plane origin distance map to obtain an optimized first plane origin distance map.

20. A non-transitory computer-readable storage medium, having stored executable depth image completion instructions that, when executed by a processor, implement the method of claim 1.
